(19) United States
(12) Patent Application Publication
(10) Pub. No.: US 2014/0115436 A1
(43) Pub. Date: Apr. 24, 2014

(54) ANNOTATION MIGRATION

(71) Applicant: APPLE INC., Cupertino, CA (US)

(72) Inventors: Donald R. Beaver, Pittsburgh, PA (US); Martin J. Murrett, Portland, OR (US); Allison M. Styer, San Francisco, CA (US); Christopher E. Rudolph, Vancouver, WA (US); Ian J. Elseth, Vancouver, WA (US); Charles J. Migos, Millbrae, CA (US); Mark A. Ambachtsheer, Vancouver (CA); Evan S. Torchin, San Francisco, CA (US)

(73) Assignee: APPLE INC., Cupertino, CA (US)

(21) Appl. No.: 13/657,831

(22) Filed: Oct. 22, 2012

(51) Int. Cl. G06F 17/00

(52) U.S. Cl. 715/229

(57) ABSTRACT

Some embodiments provide a content processing application with a novel annotation migration operation that allows the application to automatically migrate annotations from a first version of content such as a document to a second version of the content. Examples of such annotations include user-specified notes, highlights, bookmarks, and/or other annotations. The content processing application examines different sets of content segments in the second version to identify a particular set of content segments that matches a first set of content segments in the first version associated with a particular annotation. Upon identifying a matching particular set of content segments, the content processing application associates the particular annotation with the particular set of content segments in the second version. The content processing application can then provide a presentation of the second version with the particular annotation for the matching particular set of content segments.

### BACKGROUND

Document viewing and editing applications (hereafter collectively referred to as document viewers or content processing applications) provide users with the ability to read, edit, and specify a variety of annotations for documents, images, and other digital content. Examples of such applications include iBooks® and iBooks Author®, all developed and licensed by Apple, Inc. These applications give the users the ability to make a variety of annotations, including highlights of texts, notes corresponding to particular highlights, bookmarks, and other annotations in a variety of manners.

A user may over time, create numerous annotations for one particular version of a document, including numerous highlights of text throughout the document, various notes associated with the highlights, various bookmarks on different pages of the document. The user may subsequently obtain a newer version of the document on their device. However, the newer version of the document will not contain any of the user's previously specified annotations. If the user wishes to carry over their annotations from the first version of the document, the user will have to manually examine each annotation they made in the previous version of the document and determine where to create the same annotation (e.g., highlight) in the new version of the document. The user will also have to re-specify each bookmark and note for each annotation in the new version of the document. This will likely be a time consuming and onerous task for the user, especially in situations where the user has a significant number of annotations. Furthermore, this becomes even more difficult when the text within the newer version of the document has been rearranged to different locations within the document and thus would require the user to search throughout the new version of the document to find the corresponding location for an annotation.

### BRIEF SUMMARY

Some embodiments provide a content processing application with a novel annotation migration operation that allows the application to automatically migrate annotations for a first version of a content to a second version of the content. Each version of the content includes a number of content segments. The first version also includes at least one particular annotation that is specified for at least a first set of content segments in the first version.

The content processing application examines different sets of content segments in the second version to identify in an automated manner a particular set of content segments that matches the first set of content segments. Upon identifying a matching particular set of content segments, the content processing application associates the particular annotation with the particular set of content segments in the second version. The content processing application can then provide a presentation of the second version with the particular annotation for the matching particular set of content segments. In some embodiments, a user specifies the particular annotation for the first set of content segments in the first version. Examples of such annotation include user-specified notes, user-specified highlights, user-specified bookmarks and/or other user-specified annotations. In some embodiments, the content processing application automatically creates certain annotations on behalf of the user, such as implicit bookmarks that identify the last reading position of the user within a document.

In some embodiments, the first set of content segments includes a second content segment set that is annotated and a third content segment set that includes one or more content segments that are selected near the second content segment set in order to define a context around the second content segment set. When examining different sets of content segments in the second version, the content processing application in some embodiments analyzes content segment sets within a particular section of the second version that corresponds to a section in the first version. Alternatively, or conjunctively, when examining different sets of content segments in the second version, the content processing application in some embodiments (1) uses one or more of the content segments in the first set of content segments to derive a search string, and (2) applies the search string to a search index to identify a portion of the second version that contains the different content segment sets.

In some embodiments, the content is a document and the content processing application is a document viewer that presents the document. The content segments in the document in some embodiments include words, images, and/or other content segments (such as audio or video segments) that can be placed in the document viewer. In these embodiments, the annotations are specified for a first set of content segments (e.g., a first set of words, or a first set of words and images) in a first version of a document. The document viewer examines different sets of content segments in the second version to identify a particular content segment set that matches the first content segment set which has an associated particular annotation. Upon identifying a matching particular content segment set, the document viewer associates the particular annotation with the particular content segment set in the second version. The document viewer displays the second version with the particular annotation associated with the matching particular content segment set.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purposes of explanation, several embodiments of the invention are set forth in the following figures.

FIG. 1 conceptually illustrates the operation of the annotation migration tool of the document viewer of some embodiments.

FIG. 2 conceptually illustrates a hierarchical data structure for representing a structured electronic document of some embodiments.

FIG. 3 illustrates an example of an annotated word string of some embodiments.

FIG. 4 illustrates a user creating a highlight annotation within a document.

FIG. 5 illustrates a process for creating and storing an annotation for a document of some embodiments.

FIG. 6 conceptually illustrates the hierarchical data structure for representing a structured electronic document of some embodiments.

FIG. 7 conceptually illustrates a process for migrating annotations from a first version of a document to a second version of the document of some embodiments.

FIG. 8 illustrates several examples of the document viewer not detecting an exact match at the expected location within a second version of a document.

FIG. 9 illustrates the “fuzzy” matching of a word string of some embodiments.

FIG. 10 illustrates the document viewer detecting several potential matches within a particular section of a second version.

FIG. 11 illustrates the situation in which the process does not detect a match within the expected section but does detect a match at a different section within the same chapter that contains the annotation.

FIG. 12 illustrates the user interface that displays annotations of some embodiments.

FIG. 13 illustrates an annotation being migrated from a first version of a document of some embodiments.

FIG. 14 illustrates a process that uses a search index to locate a particular matching word string of some embodiments.

FIG. 15 illustrates a search index and a particular search string that is to be searched using the search index of some embodiments.

FIG. 16 illustrates a notes view of the document viewer user interface of some embodiments.

FIG. 17 illustrates the migration tool migrating a set of annotations into a second version of a document on an incremental basis of some embodiments.

FIG. 18 illustrates the document viewer migrating annotations for a particular chapter.

FIG. 19 illustrates the search tool for searching a document for a particular highlighted text of some embodiments.

FIG. 20 illustrates a copy function in the popover search tool of some embodiments.

FIG. 21 illustrates a user removing a particular annotation from their document.

FIG. 22 illustrates the document viewer migrating a user's bookmarks from a first version of a document to a second version of a document.

FIG. 23 illustrates the bookmark data structure for a bookmark in a document of some embodiments.

FIG. 24 conceptually illustrates the hierarchical tree structure of a structured electronic document of some embodiments.

FIG. 25 illustrates backing up a user's annotations to the user's cloud storage of some embodiments.

FIG. 26 conceptually illustrates the software architecture in some embodiments of a content processor that operates on a device.

FIG. 27 is an example of an architecture of a mobile computing device on which some embodiments are implemented.

FIG. 28 conceptually illustrates an electronic system with which some embodiments are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a document viewer with a novel annotation migration tool that allows the application to automatically migrate annotations for a first version of a document to a second version of the document. Examples of such a document viewer include a document reader (e.g., an electronic book reader), a document editor (e.g., a word processing application that allows the viewing and editing of a document), a web browser, or any other application through which a document can be viewed. Examples of such annotations include user-specified notes, user-specified highlights, user specified bookmarks, and/or other user-specified annotations. In some embodiments, the content processing application automatically creates certain annotations on behalf of the user, such as implicit bookmarks that identify the last reading position of the user within a document.

Each version of the document includes a number of content segments. The document viewer examines different content segment sets in the second version to identify a particular content segment set that matches a first content segment set in the first version for which a particular annotation has been specified. Upon identifying a matching particular content segment set, the document viewer associates the particular annotation with the particular content segment set in the second version. The document viewer displays the second version with the particular annotation associated with the matching particular content segment set.

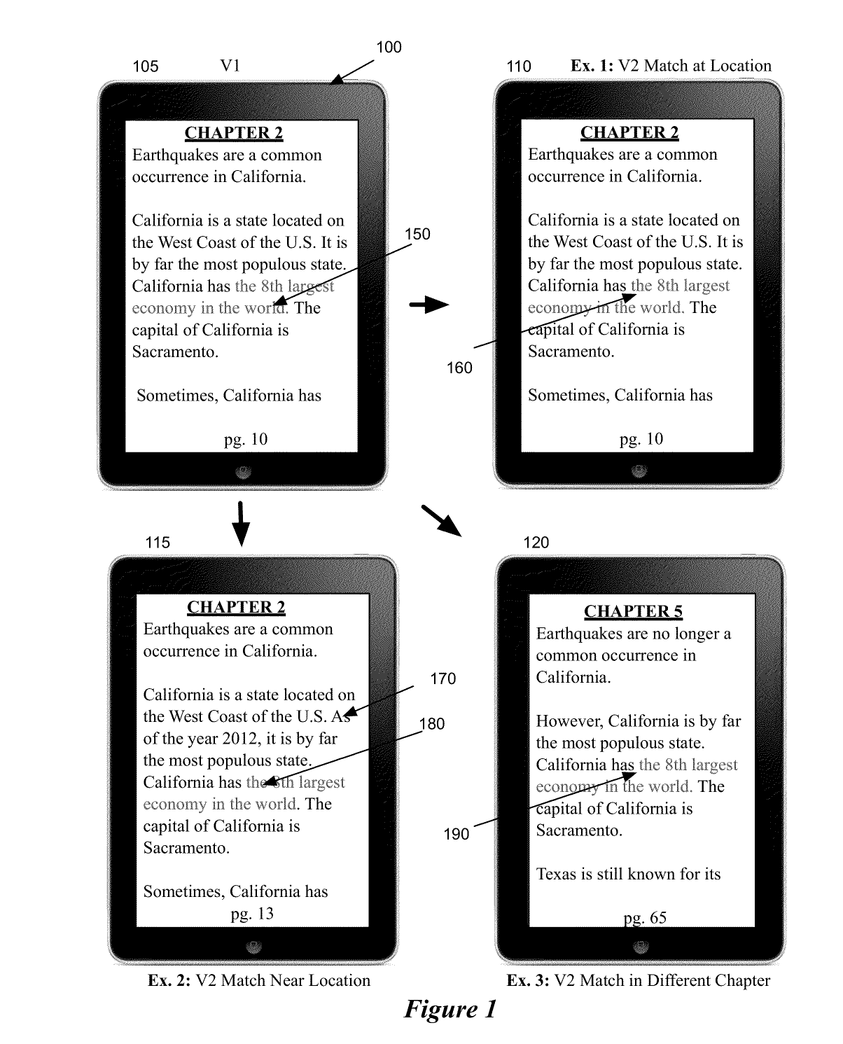

FIG. 1 conceptually illustrates an example of such a document viewer. In this example, the document's content segment sets are word strings. However, as described above and below, there is no requirement that the content segment sets be word strings. The content segment sets can include (1) any text string, (2) one or more images, other audio/video content segments, or other type of content data, and/or (3) any combination of such content segments.

FIG. 1 conceptually illustrates three examples that describe the operation of the annotation migration tool of the document viewer of some embodiments. Each example illustrates a possible scenario that the annotation migration tool may encounter when migrating annotations between two versions of a document. For each possible scenario, the annotation migration tool is able to identify the appropriate location and corresponding word string in the second version to associate with a particular annotation that was specified for the first version of the document. Accordingly, in each of these three example scenarios, the annotation migration tool has been able to successfully migrate the specified annotation from the first version of the document to a second version of the document.

FIG. 1 illustrates four views 105-120 of a device 100 on which the document viewer executes. The first view 105 displays a portion of a first version of a book, while the second, third and fourth views 110-120 display portions of three different possible second versions of the book. As shown in FIG. 1, the portion of the first version displayed in the first view is page 10 of the document, which falls within Chapter 2 of the document. In this portion, the text “the 8^{th} largest economy in the world” has been highlighted as an annotation 150 within the first version of the document.

A user may have specified this highlighting, as in some embodiments a user may highlight different portions (e.g., character, text, word, image, and/or other audio, image, or video content segments) of the document. Such highlights get stored as annotations within the document in some embodiments. The document viewer further provides the user with the ability to perform certain other functions for each highlight, including adding notes for the highlight, searching the document or the web for other locations that contain the highlighted text, and various other functions. The document viewer will display the same portion as highlighted anytime the portion is subsequently displayed to the user on the user's device. The document viewer also allows the user to view any notes previously specified for any highlighted portion of the document. In some embodiments, the document viewer allows a user to specify note annotations without highlighting any portion of the document.

The second, third and fourth views 110-120 in FIG. 1 show three different ways that the annotation migration tool of some embodiments can successfully migrate the annotation 150 in Chapter 2 of the first version of the book to three possible different second versions of the book. In some embodiments, the device may obtain a second, or subsequent version of a document by accessing a content distribution system (e.g., iTunes®). In some embodiments, the document viewer automatically notifies a user regarding an updated version for a particular document and allows the user to download the new version.

The second view 110 illustrates a basic example in which the text in the second version that corresponds to the annotated text in the first version is at the same relative position in the second version as the annotated text is in the first version. As illustrated in the second view 110, the word string “the 8^{th} largest economy in the world” 160 appears on page 10 of the Chapter 2 in the second version, which is the same exact page and chapter on which it appeared in the first version. Given that the annotated text appears in the same exact location in the first and second versions, the migration tool highlights the word string “the 8^{th} largest economy in the world” 160 in the second version to match the specified highlight 150 in the first version. In some embodiments, the migration tool performs this annotation migration when the document viewer opens the second version for the first time. As further described below, the migration tool in some embodiments might perform this migration at different times or in different ways, such as upon downloading of the second version, or in a background mode while a user is viewing the second version of the document, or at some other time and/or in some other manner.

The first example that is illustrated by the second view 110 may occur when the author or publisher of the book only added new chapters to the end of the document and thus left the initial chapters that were part of the first version unchanged. In this situation, the document viewer migrates each annotation to the same corresponding content segment set (e.g., word string) within the second version, which appears at the same relative location in the second version that the originally annotated content segment set appears in the first version.

The second example illustrated in the third view 115 presents a more complicated situation in which the second version of the document provides some additional text that was not included in the first version of the document. As such, the text in Chapter 2, version 1 and Chapter 2, version 2 is not identical. In particular, the second version has added the additional text string “As of the year 2012,” 170 to the sentence that precedes the sentence that contains the annotated word string in the first version. Furthermore, the particular page for Chapter 2 now starts on page 13 in version 2, and not page 10 in version 1.

Despite these changes, the document viewer has still been able to successfully migrate the annotation 150 into the second version of the document, as illustrated by the highlighted “the 8^{th} largest economy in the world” 180. As such, the document viewer has successfully identified the appropriate word string and corresponding location within the second version in order to migrate and incorporate the particular annotation. This situation is common when a second version of a document provides additional paragraphs or sections within a new version of a particular chapter that contains annotations. Thus, the document viewer recognizes that the particular word string for which it has to incorporate an annotation may not be at the exact location within the chapter as the original annotation, but will likely be in a relatively close, or nearby location. The document viewer need only search within the nearby vicinity, or sections, of the original location to identify the word strings and the correct location for which it has to incorporate the particular annotation for the content segment.

The third example illustrated in the fourth view 120 presents an example of the document viewer successfully migrating an annotation to a completely different chapter of the document. In certain situations, the author or publisher of the document may move various content segments, including text and paragraphs, from one particular location within the document to a completely different location within a subsequent version the document. As illustrated by the fourth view, the text string “8^{th} largest economy in the world” 190 now appears within a completely different chapter in the second version. In particular, this text string now appears within Chapter 5 of the document, and not Chapter 2. However, the document viewer has successfully recognized the word string “the 8^{th} largest economy of the world” 190 in Chapter 5 and has successfully migrated the annotated highlights for this word string from the first version to the presentation of this word string in Chapter 5 of the second version.

To successfully identify the appropriate locations of matching content segment sets (e.g., word strings) in different versions of a document, the document viewer performs different content-segment matching processes in different embodiments. For instance, in some embodiments, the content-segment matching process of the document viewer initially examines one or more content segment sets (e.g., word strings) at or near a location within a section of the second version that corresponds to a location in a section in the first version that contains the annotated content segment set, in order to find the matching particular content segment set. When it finds a matching content segment set at or near the initially searched section of the second version, the content-segment matching process associates the annotation with the matching content segment set. When the process finds multiple matching content-segment sets at or near the initial search location, the process in some embodiments selects the set that is closest to the relative position of the annotated content-segment set in the first version, or selects the closest set in a particular direction (e.g., the closest to the right of the original location).

When the process does not find the matching content-segment set at or near the initially searched location, the process in some embodiments (1) uses one or more of the content segments in the first set of content segments to derive a search string, and (2) applies the search string to a search index to identify another section of the second version to search in order to find the matching particular content segment set. Alternatively, the content-segment matching process in some embodiments uses a search index to identify another chapter that may contain the matching content-segment set, and only does this when it makes a determination that the second version does not contain the section with the annotated content-segment set from the first version. In some such embodiments, the content-segment matching process places the “orphaned” annotation at a particular default location (e.g., the end) of the second-version chapter that corresponds to the first-version chapter with the annotated content-segment set. This placement informs the user that the section containing the annotated text in the first version cannot be found in the second version.

In order to successfully migrate the annotations between different versions of a document, the document viewer creates and stores a variety of data for each particular annotation, which it may later use to perform its content-segment matching process. The data includes the location of the annotation within the document (e.g., chapter, section, offset), the content of the annotation (e.g., the highlighted content segments, the surrounding text of the highlight), and certain document-specific information including the particular version of the document in which the annotation was created.

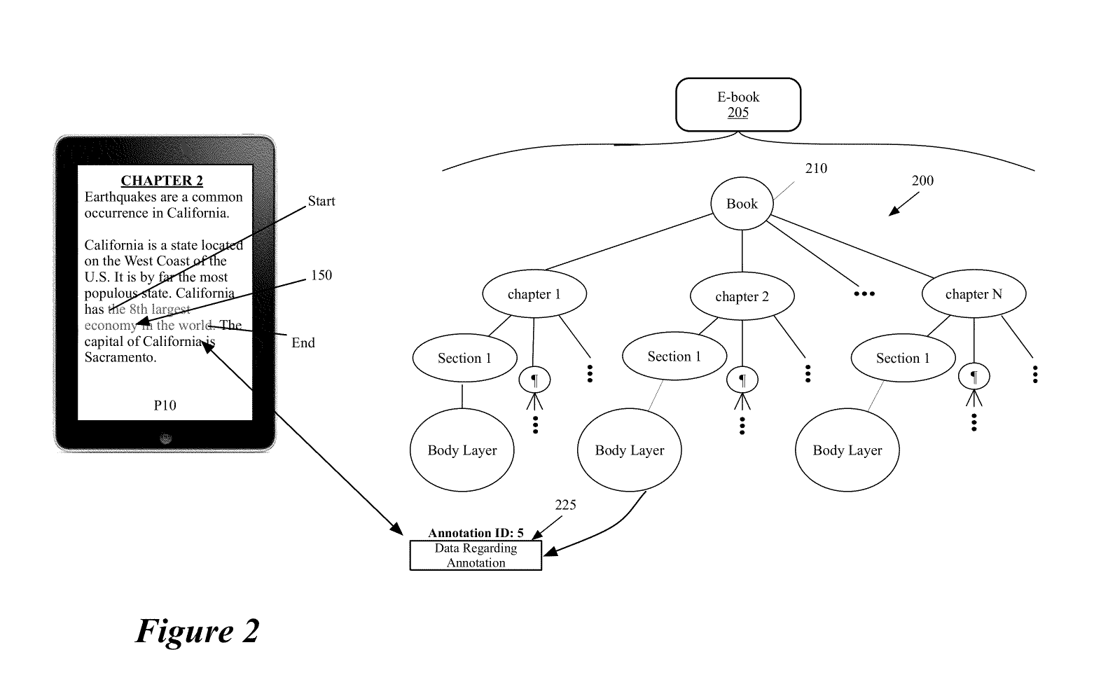

The document viewer in some embodiments uses a hierarchal data structure for efficiently storing and accessing document data. FIG. 2 conceptually illustrates an example of such a hierarchical data structure 200 for representing a structured electronic document. This figure also illustrates the annotated word string 150 being displayed by the document viewer on a device, and an example of a data structure for specifying the annotation within the hierarchical data structure 200.

The hierarchical data structure illustrated in FIG. 2 is a tree structure 200 that contains multiple levels of different nodes. The different node levels correspond to different levels of organization within the document 205. FIG. 2 illustrates that in some embodiments the document is an electronic book 205 that is organized in a hierarchical tree structure 200 based on chapters, sections, and body layers. In this figure, the tree contains a root node 210 that corresponds to the electronic book 205. The next level of nodes includes nodes representing chapters 1-N within the electronic book, as illustrated by the tree structure 200 in this figure. The chapter nodes are the child nodes of the root node. As further illustrated, each chapter node contains one or more section child nodes, which provide the next level of nodes within the tree structure. Lastly, each section node includes a body layer node that is used as a storage node to store content segments within a body layer that is specified within the section corresponding to the section node.

In some embodiments, each chapter, section and body layer node has an associated identifier (ID) value (not shown) that uniquely identifies the node. As further described below, each particular content segment in the body layer can be uniquely specified in terms of the chapter ID, the section ID, the body ID, and an offset value in the body layer. The chapter, section and body IDs can be used to identify the body layer in which the particular content segment resides, while the offset value can be used to identify the location of the particular content segment within the body layer. In some embodiments, the offset value is a number that specifies the number of content segments that precede the particular content segment in the body layer.

As illustrated in FIG. 2, the annotated word string 150 is stored in an annotation data structure 225 that is associated with (e.g., linked to) the body layer that contains the annotated word string. This data structure stores various information regarding the annotation, such as the type of annotation, the start and end of each annotated content segment set, user-specified data regarding the annotation, etc. Different embodiments use different techniques to specify the start and end of each annotated content segment set (e.g., each annotated word string). For instance, some embodiments specify the starting content segment and ending content segment in each annotated content segment set. Other embodiments specify the start content segment set and an offset from which the identity of the ending content segment in the set can be derived. Yet other embodiments specify both the start and end content segments in a set in terms of two offset values, where the first one allows for the identification of the first content segment and the second one allows for the identification of the second content segment. In addition to storing each annotated content segment set, some embodiments store one or more content segments, near or about the annotated content segment set, that define a surrounding context for the annotated set. As further described below, this context can then be used to more finely detect matching content segment sets in subsequent versions.

For each annotation, the user may specify a note to associate with the annotation. In some embodiments, the user-specified notes for an annotation are stored in that annotation's data structure or in a data structure associated with (e.g., linked to) the annotation data structure. Several examples of annotation and note data structures are provided below.

By storing the various annotation and document information in the tree structure 200, the document viewer can quickly migrate annotations between different versions of a document. The viewer simply steps through the different annotation data structures and tries to identify content segment sets in the new version of the document that match the annotated content segment sets that are identified in the data structure of the document's previous version. For instance, in some embodiments, the viewer tries to identify the matching word string in a later version for each annotated word string in the earlier version by initially examining the body layer of the section in the later version that corresponds to the section in the earlier version with the annotated word string. If it determines that the corresponding section has been deleted in the later version, then it uses the words in the word string to derive a search string in some embodiments, and then uses a search index to identify other chapters that have other sections with other body layers that might contain the matching search string.

As mentioned above, the document viewer stores the context for each annotation, and uses this context to identify potential matching content segment sets (e.g., matching word strings) in subsequent versions of the document. In other words, by using information regarding the context of a particular annotation, the document viewer can provide a greater level of accuracy for migrating annotations. One example of such context includes the surrounding text adjacent to a particular highlighted word string.

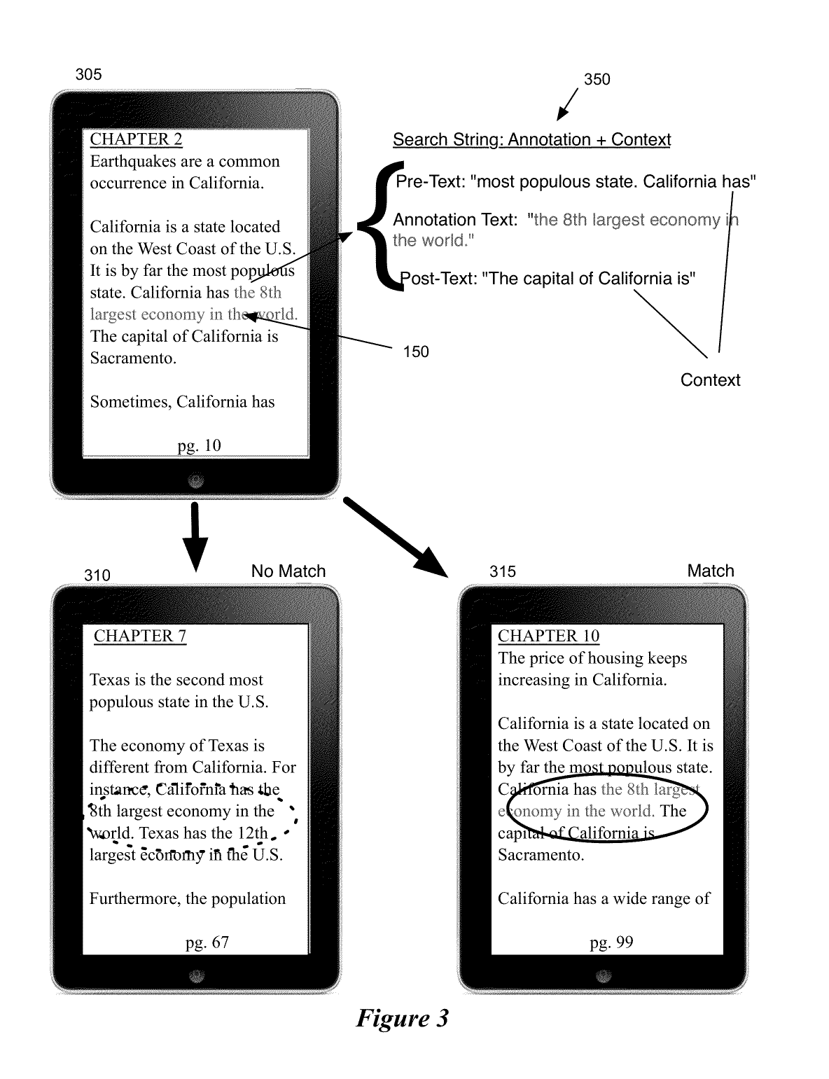

FIG. 3 illustrates one such example of a context for the annotated word string 150 of FIG. 1. FIG. 3 illustrates three views 305-315 of a device on which the document viewer executes. The first view 305 displays a portion of a first version of a document with the annotated word string “the 8^{th} largest economy in the world” 150. For this annotation, the context is specified by a pre-text string field that contains the content segments “most populous state. California has” and by a post-text string field that contains the content segments “The capital of California is”. FIG. 3 also illustrates that the combination of the pre-text and post-text strings along with the annotated word string 150 forms a search string 350. To identify the matching content segment set, the document viewer searches the later version of the document to find a text string that matches the search string 350. Using the pre-text and post-text strings in addition to the annotated string increases the likelihood that the document viewer will find the correct content segment set in the later version that matches the annotated content segment set in the earlier version.

The second and third views 310 and 315 in FIG. 3 illustrate two different portions of the second version of the document. The second view 310 illustrates a portion of Chapter 7 of the second version, which contains the word string “the 8^{th} largest economy in the world” on page 67 of the document. However, the surrounding context text adjacent to this word string is different from the context text adjacent to the annotated text in the first view 305. In particular, for this page of the document, the pre-text string contains the content segments “different from California, For instance, California has” and the post-text string contains the content segments “Texas has the 12^{th} largest”. As these pre-text and post-text strings differ from the pre-text string “most populous state. California has” and post-text string “The capital of California is”, the document viewer determines that the word string on page 67 does not match the annotated word string, even though the annotated text portions are identical.

The third view 315 illustrates a portion of Chapter 10 of the second version, which also contains the word string “the 8^{th} largest economy in the world” on page 99 of the document. In this situation, both the annotation text string and the context text string match at this particular location. Specifically, page 99 includes the pre-text string “most populous state. California has” and post-text string “The capital of California is” before and after the word string “the 8^{th} largest economy in the world.” As such, the document viewer migrates the annotation to this particular word string at this particular location within the second version of the document.

In the example illustrated in FIG. 3, the document viewer analyzes chapters 7 and 10 for the matching content segment set for different reasons in different embodiments. For instance, in some embodiments, the document viewer only analyzes other chapters when it determines that the section in chapter 2 that contained the annotated text no longer exists in the second version. In some such embodiments, the document viewer makes this determination by initially searching for the section ID for the section that contains the annotated text in the e-book data structure of the second version. When it does not find this section ID, it determines that the section has been deleted from the new version, and then searches for another chapter that contains the annotated word string. As mentioned above and further mentioned below, the document viewer quickly identifies such chapters by using the words in the word string to identify chapters that contain some or all of the words in the annotated word string. In other embodiments, the document viewer uses other schemes to specify when it should examine other sections and/or chapters for matching content segment sets. For example, in some embodiments, the document viewer not only uses the content segments (e.g., words) in the annotated content segment set (e.g., in the annotated word string) to identify a search string that is applied to a search index in order to identify the appropriate chapter or section for examination, but also uses the content segments (e.g., words) in the context to identify the search string. Also, in some embodiments, the document viewer examines other chapters or sections even when the section that contained the annotated content segment set is not deleted in the newer version of the document.

The context of an annotation is particularly useful in situations where the user has highlighted a relatively short phrase. For example, when a user highlights only a single word within the document, the context of the word becomes essential since the word is more likely to appear in numerous locations within the document than a longer phrase containing the word. In some embodiments, the document viewer analyzes more context words when a user highlights a relatively short phrase. In other situations, the document viewer analyzes fewer context words when analyzing a longer word string. Several more detailed embodiments are described below. Section I describes the annotation creation process and data structure for a particular document. Section II describes the annotation migration process for migrating annotations from a first version of a document to a second version of the document. Section III describes the software architecture of a content processor that uses an annotation migration tool in some embodiments. Section IV describes an electronic system that implements some embodiments of the invention.

### I. Annotation Creation

Different types of annotations (e.g., highlights, notes, bookmarks) can be created for a particular document through several mechanisms. For instance, a user can create a variety of highlight annotations and notes throughout different portions of a document through various user input.

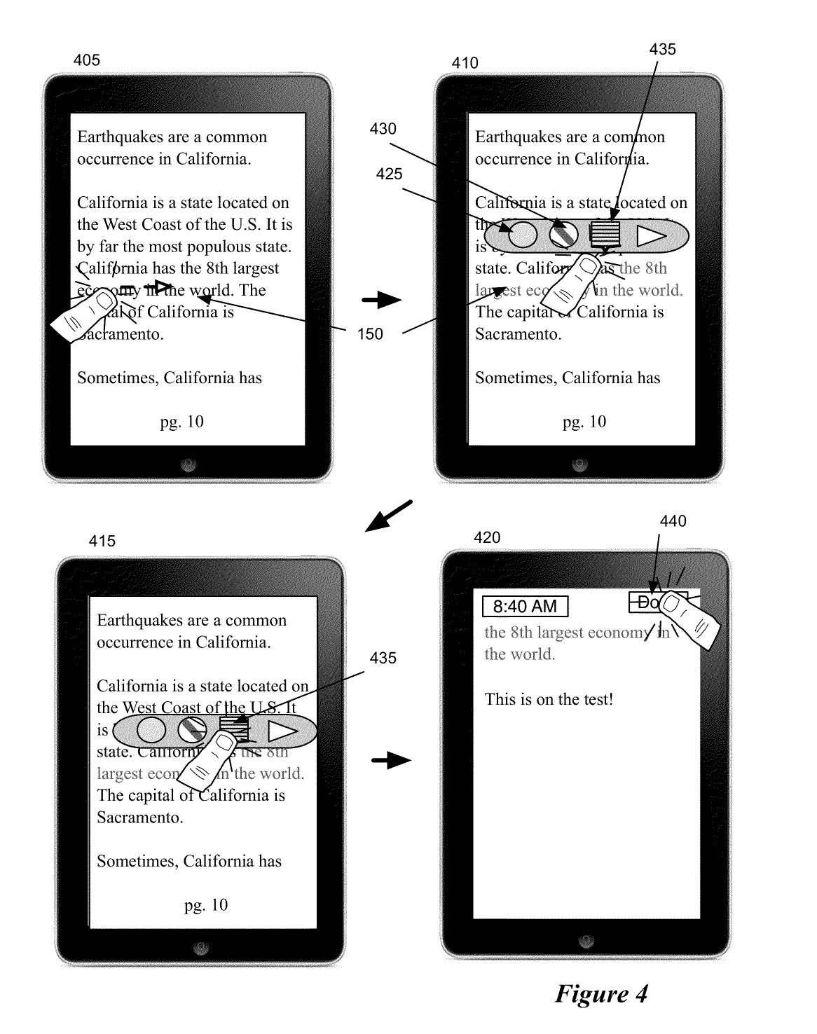

FIG. 4 illustrates one such example of a user creating an annotation. FIG. 4 illustrates, in four stages 405-420 of a device on which a document viewer is executing, a user creating a highlight annotation for a portion of text within a document and inserting a corresponding note for the highlight. The first stage 405 illustrates the document viewer displaying a portion of a book. The device is receiving gestural input from a user regarding a portion of the text that the user would like to highlight. In some embodiments, the user makes the gestural input by tapping a touchscreen of the device at the particular location that the user would like to begin highlighting. After the initial tap, the user completes the gestural input by swiping (e.g., a stylus, a finger) along the screen over the particular text the user would like to highlight. In this stage, the user is tapping and swiping a finger along the text “the 8th largest economy in the world” 150. In some embodiments, the user indicates the particular text to be highlighted through alternative mechanisms including using a touchscreen keyboard, a smart pen, or other shortcut menus and shortcut keys (e.g., “command X”, “command V” etc.).

Stage 410 illustrates the document viewer displaying the portion of text, “the 8^{th} largest economy in the world” 150 as highlighted within document. Furthermore, the document viewer is displaying a tool bar that contains several icons 425-435 of additional tools that the user may access. The style icon 425 allows the user to change the color and style that is used to display the highlighted text. The remove highlight icon 430 allows the user to remove a highlight that was previously made for a portion of text. The notes icon 435 allows the user to add notes to the corresponding highlight. In some embodiments, the toolbar is displayed based on a gesture input from the user. In this example, the user is tapping the touchscreen to display the toolbar. In other embodiments, the toolbar is displayed by other mechanisms (e.g., menu selection).

Stage 415 illustrates the user selecting the notes icon 435 from the toolbar. Stage 420 illustrates the device displaying a notes user interface in which the user has input a note, “This is on the test”, to be associated with the selected text. In some embodiments, the note is stored as a note annotation associated with the highlight annotation. The document viewer also stores a timestamp for each highlight and note annotation. Stage 420 illustrates the user selecting the “Done” icon 440 to indicate that the user has finished adding the note for the particular highlight. After the user selects the “Done” icon 440, the document viewer returns to displaying the same portion of text that was displayed (i.e., as shown at stage 415) prior to the user entering the notes UI screen. The user may then proceed to create other highlights in other locations of the document. All of these highlights and notes get stored as annotations within the document. Furthermore, for each annotation, the document viewer stores numerous other information, including the location of the annotation within the document, the time the annotation was created and/or edited, the text surrounding the annotation, and various other data.

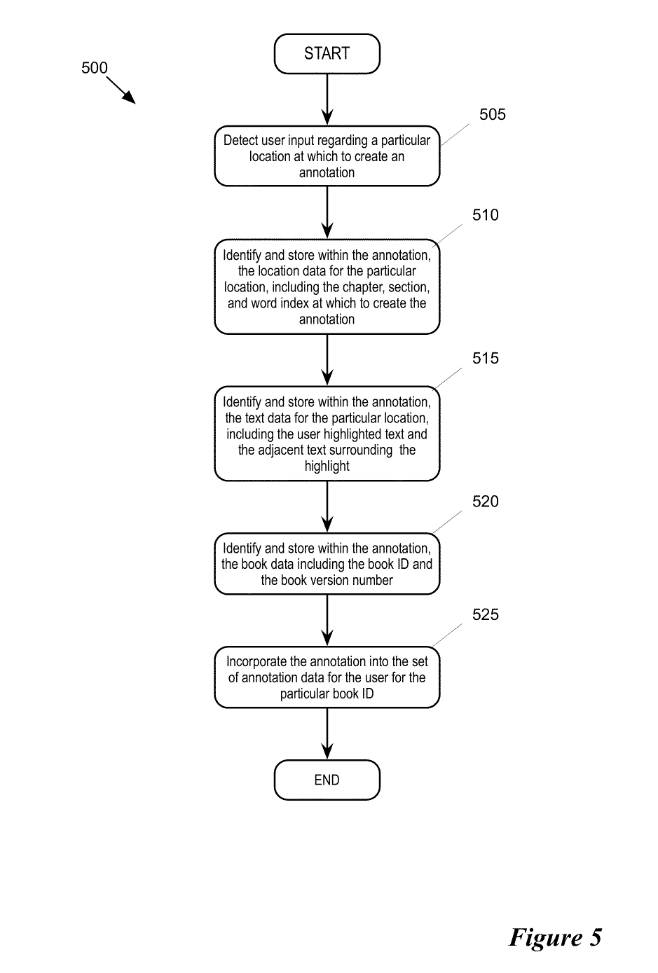

FIG. 5 illustrates a process for creating and storing an annotation for a document. Certain stages of the process will be described with reference to FIG. 4 described above. The process initially detects (at 505) a user's input of a location related to a particular word string at which to create an annotation. The input can be gestural input as described above in stage 405 of FIG. 4. The input identifies the word string within the document that the user would like to annotate. For example, as illustrated in stages 405 and 410, the user's input indicates the word string “the 8^{th} largest economy in the world” is to be highlighted as an annotation 150 within the document.

The process next identifies and stores (at 510) the location data for the particular annotation. The process stores this information in an annotation data structure. The location data identifies the precise location of the word string within the document. This location can be specified using the organizational structure of the document. For instance, in some embodiments, the process stores the chapter, section, and a word index or offset of the location of the text string within the document. In some embodiments, the process stores the offset of the first word within the document and an offset for the last word within the annotation. In some embodiments, the process stores the page number of the page that contains the word string within the document. As illustrated in stage 405 of FIG. 4, the process could store the page number “10” within the annotation data structure for the corresponding annotation.

After the process identifies and stores the location data, the process identifies and stores (at 515) text data for the particular annotation. The text data includes the particular highlighted word string indicated by the user. The text data also includes the surrounding context word strings adjacent to the highlighted text. As illustrated in stage 405 of FIG. 4, the highlighted text string that is stored within the annotation data structure is “the 8^{th} largest economy in the world”. The context text strings that are stored include the pre-text string “most populous state. California has”, and the post-text string “The capital of California is”.

The process next identifies and stores (at 520) certain book-specific information for the particular annotation. The book information includes the Book ID number, similar to a book's ISBN, as well as the book's version number. Storing a version number for each annotation is important in situations where a user downloads a different version of a book and thus the document viewer needs to migrate annotations between the different versions of the same book.

The process then incorporates (at 525) this annotation data into the set of annotation data for the particular document and version stored on the user's device. The process then ends.

Each annotation data structure corresponds to a particular word string at a particular location within the structured electronic document. A brief overview of the relationship between the annotation data structure and the hierarchical tree structure of the electronic document is provided by reference to FIG. 2, above. As described by reference to FIG. 2, the document viewer in some embodiments uses a hierarchal data structure to efficiently store and access document data. A more detailed example of a hierarchical structure is described next.

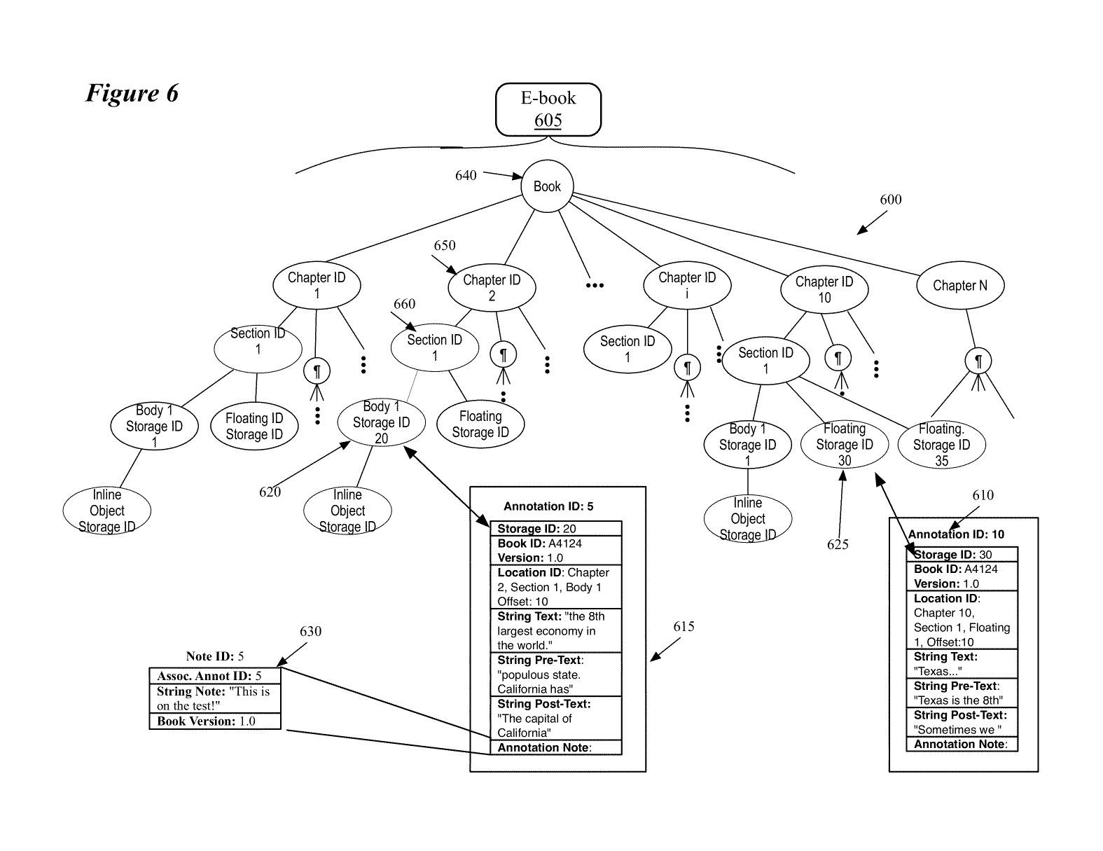

The hierarchical data structure illustrated in FIG. 6 is a tree structure 600 that contains multiple levels of different nodes that correspond to different levels of organization within the document. FIG. 6 illustrates that in some embodiments the document is an electronic book 605 that is organized according to the hierarchical tree structure 600, based on chapters and sections that each include a body layer and one or more floating layers. This figure also illustrates annotation data structures 610 and 615 and their relationship to the hierarchical tree structure 600.

As illustrated, each chapter node contains one or more section child nodes, which provide the next level of nodes within the tree structure. Each section node includes a body child node and one or more floating child nodes, which provide another level of nodes within the tree structure. Lastly, each body node includes an inline child node.

Each of the body nodes, floating nodes, and inline nodes may be used as a storage node to store content segments within the electronic book 605. In some embodiments, each storage has an associated identifier, or unique Storage ID, that uniquely identifies the storage. In some embodiments, this Storage ID may be a Globally Unique Identifier, or GUID, within the document. The GUID is a unique identifier that is used to identify a particular storage within the document. In addition, each storage node may be identified within the hierarchical tree structure 600 using location information. In particular, each storage node can be uniquely specified in terms of the chapter ID, section ID, and either a body ID, a floating ID, or an inline ID.

In some embodiments, content is defined within both the body layer and the floating layer. Content in the body layer is placed “in line” (i.e., two pieces of content cannot overlap in the body layer) in some embodiments. In contrast, content within the floating layer can overlap with other content within the floating layer. In other words, content in the floating layer may occlude other content in this layer. Consequently, in these embodiments, adding new content or dragging existing content within the floating layer may result in overlapped content.

Content in the floating layer is not affected by content in the body layer of the document. Content in either the floating or body layer can be replaced with new content without affecting content in the other layer. Thus, the floating object nodes exist within a section of the document independent of the body object nodes. In particular, the body object nodes typically have a relationship to other body object nodes, such as a sequential or in-line relationship, in some embodiments.

When a user highlights a particular word string within the electronic document, as described in FIG. 3, the document viewer creates an annotation for that particular word string. The document viewer stores various information for each particular annotation, including the exact word string that the user highlighted, certain surrounding contextual text that is adjacent to the word string, the location of the word string within the electronic document which can be used to identify the particular storage node that contains the word string, and various information regarding the document that the annotation was created for. The document viewer stores this information within an annotation data structure.

Each annotation data structure, 615 and 610, is associated with a particular node of the tree structure 600 that contains the word string corresponding to the annotation. The annotation data structures each include the following fields: an Annotation ID, a Storage ID, a Book ID and Version number, a Location ID, a Body Index, a String Text, a String Pre-Text, a String Post-Text, and an Annotation Note.

The Storage ID identifies a particular storage (e.g., body node, floating node, or inline node) within the electronic document structure that contains the content segments, or word string, associated with the particular annotation. As illustrated, annotation data structure 615 with Annotation ID “5” contains within its Storage ID the number “20”. This Storage ID corresponds to body object node 620 in the hierarchical tree structure 600, as illustrated by the arrow from the annotation data structure to this node. Likewise, annotation data structure 610 with Annotation ID “10” contains within its Storage ID the number “30”. This Storage ID corresponds to floating object node 625 in the hierarchical tree structure 600, as illustrated by the arrow from this annotation data structure to this node.

The Book ID identifies the unique book identification number, similar to an ISBN number of the book. Each annotation is stored specifically for a particular book or document, as identified by its Book ID number Annotation data structures 615 and 610 both contain the Book ID number A4124, because both annotation data structures 615 and 610 relate to the same book 640.

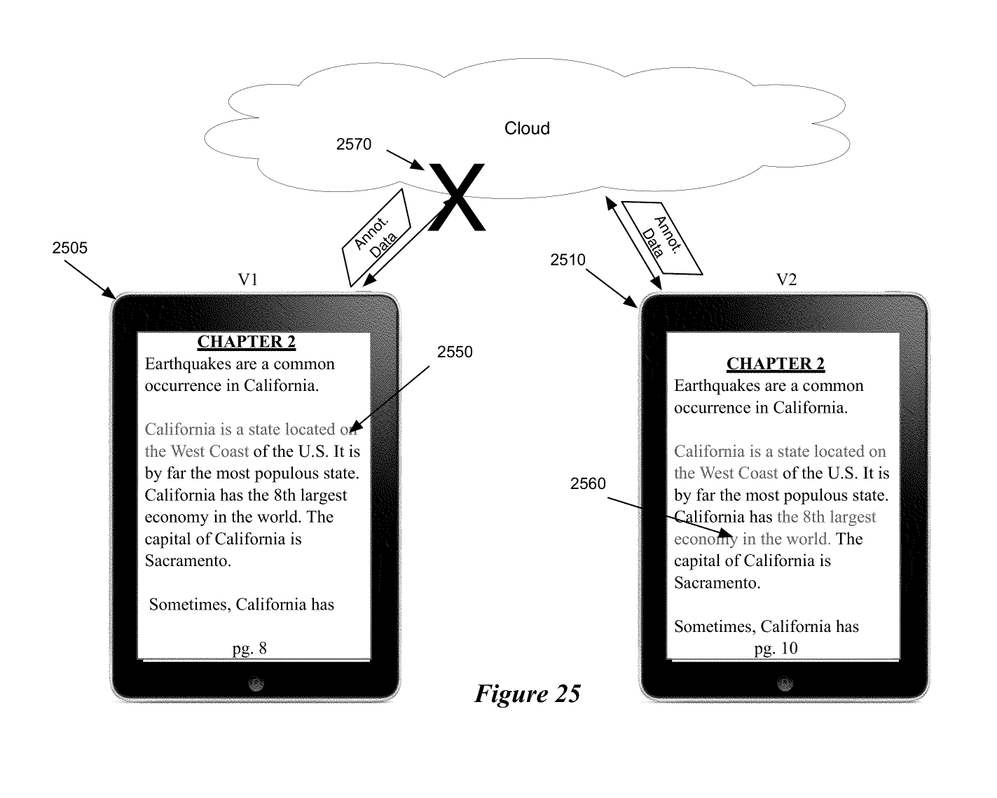

The Book Version number identifies the particular version of the document that the annotation was created within. As illustrated, annotation data structures 615 and 610 both indicate that they correspond to book version 1.0. This version number is important to the annotation migration process since this process is executed when a device receives a different version of a document from that already stored on the device. The document viewer uses this version number when determining whether to migrate annotations from a particular version of a book to a newly received version of the same book. In some embodiments, the document viewer will only migrate annotations to a subsequent version of a document. Thus if a user's device currently contains version 3 of a document and subsequently downloads an older version 2 of the document, the document viewer will not migrate the annotations from the version 3 document to the version 2 document in some embodiments. Furthermore, in some embodiments, the cloud storage that automatically backs-up data on a user's device will also not accept annotations from an earlier version of a document once a user has obtained a newer version of the document on any of their devices that is synced with the cloud storage. This is described in more detail below with reference to FIG. 25.

Furthermore each annotation data structure includes a Location ID that is used to locate a content segment associated with the annotation within a particular storage. The Location ID identifies the location of the content segment within a particular storage in the hierarchical tree structure 600. The Location ID can be used as an alternative, or supplement, to the Storage ID in certain situations to locate a particular storage. In particular, this Location ID is specified using the particular chapter ID, section ID, body ID or Floating ID, and an offset value in the body layer. The chapter, section and either the body or floating IDs can be used to identify the storage node that contains the particular content segment, while the offset value can be used to identify the location of the particular content segment within the storage node. In some embodiments, the offset value specifies the number of content segments that precede the particular content segment in the storage.

Annotation data structure 615 contains within its Location ID four values: Chapter 2, Section 1, Body 1, and Offset 10. As such, this annotation corresponds to a word string within an in-line body portion of Chapter 2, Section 1 of the document. The particular word string is at an offset of 10 within this particular section. Likewise, annotation data structure 610 contains within its Location ID four values: Chapter 10, Section 1, Floating 1, and Offset 10. As such, this annotation corresponds to a word string within a floating portion of Chapter 10, Section 1.

The String Text field stores the word string of the highlighted content segment specified by the user for the particular annotation Annotation data structure 615 contains the highlighted text string “the 8^{th} largest economy in the world.” Likewise, annotation data structure 610 contains the highlighted text string “Texas . . . ”.

The context includes the surrounding text that is adjacent to the highlighted word string. The String Pre-Text and String Post-Text fields store contextual text for each annotation. The document viewer uses this context when identifying potential matching word strings for the particular annotation. Annotation data structure 615 contains within the String Pre-Text field the word string “populous state, California has” and within the String Post-Text field, the word string “The capital of California”.

Annotation Note Field stores user-entered notes associated with an annotation. The Annotation Note field of annotation data structure 615 provides a separate note data structure 630 that stores certain information for the particular note. As illustrated, note data structure 630 includes a Note ID that identifies the particular note, an Associated Annotation ID that identifies the Associated Annotation for the note, a String Note field that contains the word strings input by the user and a Book Version number to indicate which version of a book the particular note was created for. As shown in this example, the note 630 specifies values for String Note “This is on the test!” and Book Version “1.0”.

Using the information from one or more fields of an annotation data structure, the document viewer can locate a word string corresponding to a particular annotation within a document using several mechanisms. In some embodiments, the document viewer may initially use the Storage ID within the annotation data structure to locate a particular word string within the structured electronic document. As each body node, inline node and floating node contains a unique Storage ID, the document viewer can directly access these particular storage nodes using the Storage ID number of that node.

Likewise, during the annotation migration process, in order to identify the expected location of a word string within a second version of a document, the document viewer will first examine the annotation data structure for a particular annotation of a first version of a document to identify the particular storage ID of the annotation. Once the document viewer knows the storage ID value, it can directly access the same storage ID within the second version of the document to examine whether it contains a matching word string.

The Storage ID is particularly useful in situations where an author of a first version of a document reorganizes a second version of the document such that that a particular section of the document is now placed in a different location within the second version of the document. For example, if the author of a first version of a document takes the first section of the first chapter and places this in the last section of the last chapter within the second version of the document, the document viewer can quickly identify the correct section to migrate any annotations, (e.g., from the first section of the first chapter to the last section of the last chapter) as long as the storage ID values are the same between the first version and the second version for that particular storage node.

In certain situations, a document may not use the same storage ID for corresponding storage nodes in different versions of the document. As such, in some embodiments, the storage ID alone of a particular node in a first version of a document may be insufficient to locate the node within a second version of the document.

In particular, in situations where the document viewer lacks confidence that it has the correct storage ID within a particular version of a document, or where the storage ID does not exist in the second version of the document, the document viewer may rely on other information within the Location ID to locate a particular word string within the document. For example, had annotation data structure 615 not had a value within the Storage ID that correctly identified the body object node 620, the document viewer could use the Location ID information to locate the particular body node 620.

As illustrated, Annotation data structure 615 contains the Location ID value of Chapter 2, Section 1, Body 1, Offset 10. The document viewer uses the Location ID information in order to traverse the tree from the root 640 to the correct storage node. In particular, the document viewer begins at the root node 640 and compares Chapter 2 to each child node of the root node. When the document viewer identifies the correct child node 650 corresponding to Chapter 2, the document viewer proceeds to examine the section level nodes for this chapter node 650. The process next locates the Section 1 node 660. After identifying the correct section node, the process identifies the body object node 620 that contains the particular word string associated with the particular annotation data structure 615. As such, in situations where an annotation data structure does not contain a Storage ID, or contains an inaccurate Storage ID, or a Storage ID that no longer exists, the document viewer may use the Location ID to traverse the hierarchical tree structure to locate a particular storage that contains a particular word string. By storing several types of location information, including the Storage ID and the Location ID, the document viewer can use each particular type of location information when other location information is not available or as a supplement to verify the accuracy of the storage node (body, floating, inline node) that has been identified.

Furthermore, by storing the various annotation and document information in this particular organizational structure, the document viewer can quickly migrate annotations between different versions of a document in an accurate and efficient manner. Likewise, by storing the different pieces of information, the document viewer can successfully migrate annotations in a variety of different scenarios.

FIG. 6 also illustrates the second annotation data structure 610 with annotation ID: 10. This annotation data structure 610 corresponds to the floating object node 625. As described above, each Section node may contain a body object node or a floating object node. Furthermore, each floating object node can be associated with a particular annotation, as illustrated by the arrow between annotation data structure 610 and floating object node 625. Furthermore, the document viewer can quickly identify the floating object node 625 using either the Storage ID value of 30 stored in annotation data structure 610 or the Location ID of Chapter 10, Section 1, Floating 1. The document viewer of some embodiments uses the same process to locate an annotation for a floating object node as it does for the body nodes.

Ii. Annotation Migration

Some embodiments of the document viewer provide a novel annotation migration operation that allows the application to automatically migrate annotations for a first version of a document to a second version of the document. Each version of the document includes a number of content segments. The first version also includes at least one particular annotation that is specified for at least a first set of content segments in the first version.

As described above, the content segments in the document in some embodiments include words, images, and/or other content segments (such as audio or video segments) that can be placed in the document viewer. In these embodiments, the annotations are specified for a first set of content segments (e.g., a first set of words, or a first set of words and images) in a first version of a document. The document viewer examines different sets of content segments in the second version to identify a particular content segment set that matches the first content segment set that has an associated particular annotation. Upon identifying a matching particular content segment set, the document viewer associates the particular annotation with the particular content segment set in the second version. The document viewer displays the second version with the particular annotation associated with the matching particular content segment set.

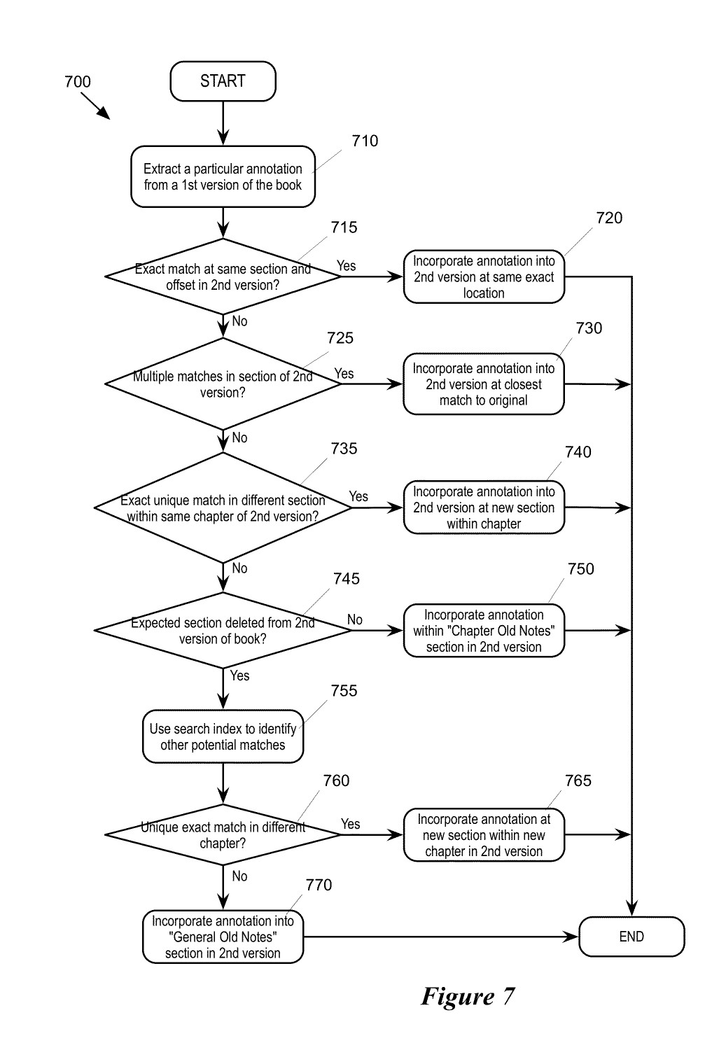

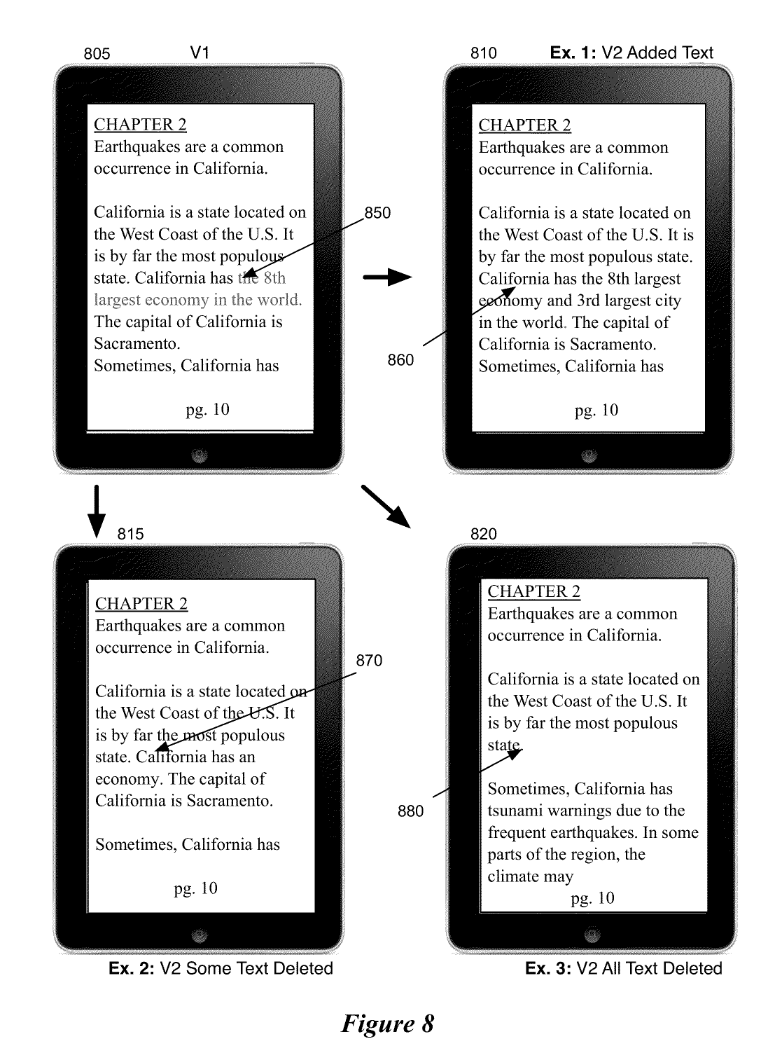

FIG. 7 conceptually illustrates a process of some embodiments for migrating annotations from a first version of a document to a second version of the document. The process is described by reference to FIGS. 8-16. In some embodiments, this process is performed by a migration tool of the document viewer operating on a device.

The process 700 begins by extracting (at 710) a particular annotation from a first version of a document, such as a book. In some embodiments, the process incrementally extracts only those annotations of a particular chapter of the book that is currently being displayed on the user's device. In some embodiments, the process extracts all of the annotations when the document viewer opens the second version for the first time. As further described below, the migration tool in some embodiments might perform this process at different times or in different ways, such as upon downloading of the second version, or in a background mode while a user is viewing the second version of the document, or at some other time and/or in some other manner.

The process next determines (at 715) whether a unique matching word string exists at the exact expected location within the second version of the document to the annotated text. For explanation purposes with respect to FIG. 7, the location is the same section in the second version as the section that contains the annotated text in the first version. Furthermore, the exact expected location is the same relative position (e.g., offset) in the second version as the annotated text is in the first version. In different embodiments, the location may be defined with respect to a different characteristic of a document. For example, the location may be a chapter, a page, a paragraph, or other portion of the document.

When the process 700 determines there is an exact match, the process proceeds to 720, which is described below. When there is not an exact match, the process transitions to 725 to determine if there are multiple matches. FIG. 8 illustrates several examples of the document viewer not detecting an exact match at the expected location within a second version of a document.

FIG. 8 illustrates four views 805-0820 of the device on which the document viewer executes. The first view 805 displays a portion of a first version of a book, while the second, third and fourth views 810-820 display portions of three different possible second versions of the book. As shown in the first view 805 in FIG. 8, the portion of the first version displayed in the first view is page 10 of the document, which falls within Chapter 2 of the document. In this portion, the text “the 8^{th} largest economy in the world” has been highlighted as an annotation 850 within the first version of the document.

The second, third and fourth views 810-820 in FIG. 8 show three different scenarios in which the annotation migration tool of some embodiments does not migrate an annotation to a second version of the book. In particular, the process does not detect an “exact match” at the exact expected location (e.g., same section and offset) of the second version of the document. The second view 810 illustrates the example in which the text in the second version at the exact expected location (e.g., that corresponds to the location of the annotated text in the first version) contains additional words that are not included in the annotation. As illustrated in the second view 810, the word string 860 that appears on page 10 of Chapter 2 now states “the 8^{th} largest economy and 3^{rd} largest city in the world.” (i.e., the underlined portion indicating the additional words). By including the additional words in the second version, the annotation migration tool does not consider this word string to be an exact match to the word string in the annotation. Thus the tool does not highlight this word string in the second version of the document.

The second example illustrated in the third view 815 illustrates the example in which some words that were included within the annotation in the first version of the document are deleted from the text in the second version at the exact expected location. As illustrated in the third view 815, the word string 870 that appears on page 10 of Chapter 2 in the second version, which is the same exact page and chapter as in the first version, now states “California has an economy.” As certain words are deleted, in particular “the 8^{th} largest economy” in the second version, the annotation migration tool does not consider this word string 870 to be an exact match at the exact expected location for the particular annotation. Thus the tool does not highlight this word string in the second version of the document.

The third example illustrated in the fourth view 820 illustrates the example in which all of the words that were included within the annotation in the first version of the document are deleted from the text in the second version at the exact expected location. As illustrated in the fourth view 820, the word string 880 that appears on page 10 of Chapter 2 in the second version, which is the same exact page and chapter as in the first version, now is devoid of any text regarding the California economy. By deleting all of the words within the annotation, the annotation migration tool does not detect an exact match at the exact expected location for the particular annotation. Thus the tool does not highlight any word strings in the second version of the document.

Returning to the process of FIG. 7, when the process detects an exact match at the exact expected location of the second version, the process 700 incorporates (at 720) the annotation from the first version of the document into the second version of the document at the same exact location. The second view 110 of FIG. 1, described above, illustrates the situation where the annotation migration process detects an exact match at the exact expected location. As illustrated, the annotation migration process highlights the same annotation 160 within the second version of the document when it detects an exact match.

In some embodiments, the process 700 does not require that an “exact match” (at 715) be made within the exact expected location, but rather, that the match meet certain criteria in order to migrate a particular annotation from a first version of a document to a second version of the document. In these embodiments, when the process determines that none of the criteria are satisfied, the process transitions to 725, described below. However, in these embodiments, when sufficient criteria are met, a “fuzzy” match is made in these embodiments.

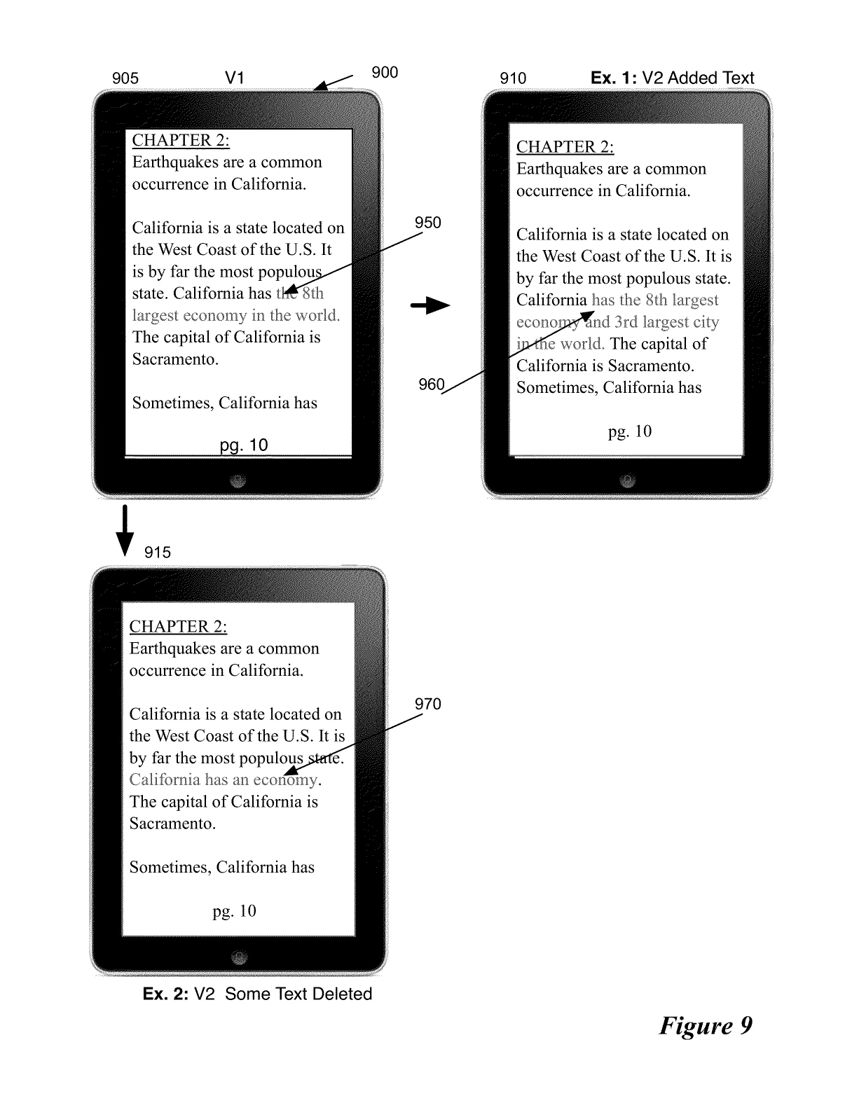

FIG. 9 illustrates two examples, similar to views 810 and 815 of FIG. 8, but in these examples the annotation migration process has migrated the annotations into the second version of the document at the expected locations despite no exact match. In particular, FIG. 9 illustrates in three views 905-915 of a device 900 on which the document viewer executes, examples of the migration tool recognizing such a “fuzzy” match.

View 905 is similar to view 805, view 910 is similar to view 810, and view 915 is similar to view 815 of FIG. 8. However, in views 910 and 915, the annotation migration tool has migrated the annotation 950 from the first version to the second version. In particular, view 910 illustrates that the word string “has the 8^{th} largest economy and 3^{rd} . . . largest city in the world” 960 has been highlighted, even though it is not an “exact match” or identical to annotated text 950 within the first version of the document. Likewise, view 915 illustrates that the word string “California has an economy” 970 has been highlighted, even though it is not identical to the word string in the annotation 950 of the first version. In some embodiments, the annotation migration tool applies a variety of factors in determining a “fuzzy” match at which to incorporate an annotation. The factors may include the particular location of the candidate word string in the second version as compared to the location of the annotation in the first version, the similarity between the candidate word string and the word string in the annotation, other potential matching candidate word strings within the document, the particular words within the candidate word string, the context words surrounding the candidate word string, and numerous other factors. In some embodiments, the document viewer presents to the user all possible matching candidate word strings and allows the user to select the particular word string at which to migrate a particular annotation.

After failing to find an exact or “fuzzy” match, the process 700 next determines (at 725) whether there are multiple matches within the expected location (e.g., section) of the second version. As described above, in some embodiments, the expected location is the same section in the second version as the section that contains the annotated text in the first version. When there are not multiple matches at the expected location, the process transitions to 735, which is described below. When there are multiple matches at the expected location, the process transitions to 730 and incorporates the closest matching word string to the original location.

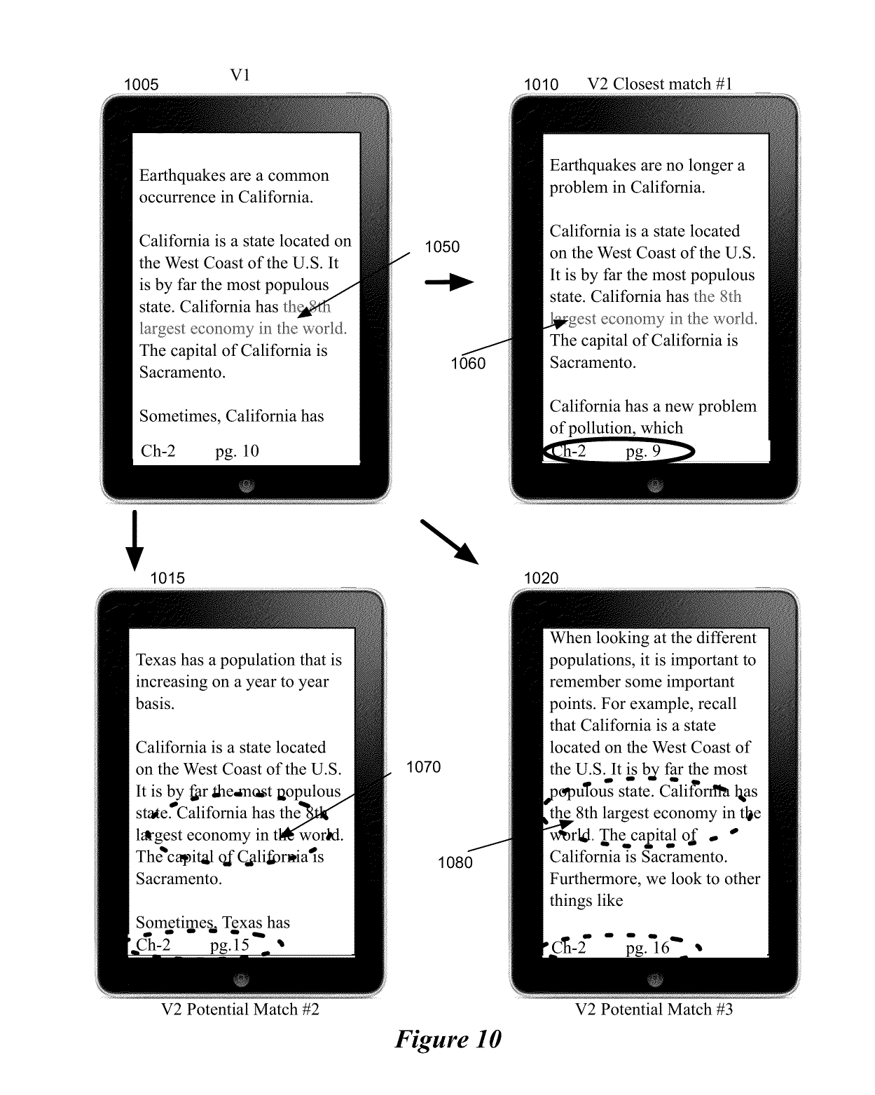

FIG. 10 illustrates an example of the document viewer not detecting an exact match at the exact expected location (e.g., same section and offset) within a second version of a document, but detecting several potential matches within the location (e.g., the same section of the second version). Specifically, FIG. 10 illustrates four views 1005-1020 of the device on which the document viewer executes. The first view 1005 displays a portion of a first version of a book, while the second, third and fourth views 1010-1020 display different portions of a second version of the document that contain three different potential matches for the annotation. As shown in the first view 1005, the portion of the first version displayed in the first view is page 10 of the document, which falls within Chapter 2 of the document. In this portion, the word string “the 8^{th} largest economy in the world” has been highlighted as an annotation 1050 within the first version of the document.

The second, third and fourth views 1010-1020 show the same text as the text of the annotation, but on different pages of the document in a different version from those of the first view. In this example, even though the portions of the document being displayed are on different pages within the same particular chapter, they are within the same section level storage node as related to the hierarchical tree structure illustrated in FIG. 6 above. That is the three different pages are still within the same body layer storage of the tree. In particular, the process 700 has detected a match at three offsets within a particular section of the second version of the document.

In particular, the second view 1010 illustrates that the word string “the 8^{th} largest economy in the world” 1060 appears on page 9 of Chapter 2. The third view 1015 illustrates that the word string “the 8^{th} largest economy in the world” 1070 once again appears on page 15 of Chapter 2 and the fourth view 1020 illustrates that this word string 1080 appears again on page 16 of Chapter 2.

Returning to process 700 of FIG. 7 when the process detects (at 725) multiple matches in the same section of the second version of the document, the process 700 incorporates (at 730) the annotation at the word string that is at a offset within the second version of the document that is closest to the offset of the annotation in the first version.

Referring back to FIG. 10, the tool determines the match that is positioned closest to the position of the version 1 text location. The migration tool has determined that the word string 1060 on page 9 of the document is closer to page 10 of the first version than the word string 1070 on page 15 or the word string 1080 on page 16 of the third and fourth views 1015 and 1020. Thus, in view 1010 the annotation has been placed within the document.

Although the examples above involve differences in page numbers, in some embodiments the process 700 does not analyze page number differences, but rather the differences in offset between different potential matching locations within a section and the original annotation location within the same section. In some embodiments, when two potential matching locations have an equal difference in offset, the annotation migration process selects the matching location to the right of the original annotation location. In other embodiments, when two potential matching locations have an equal difference in offset, the annotation migration process selects the matching location to the left of the original annotation location

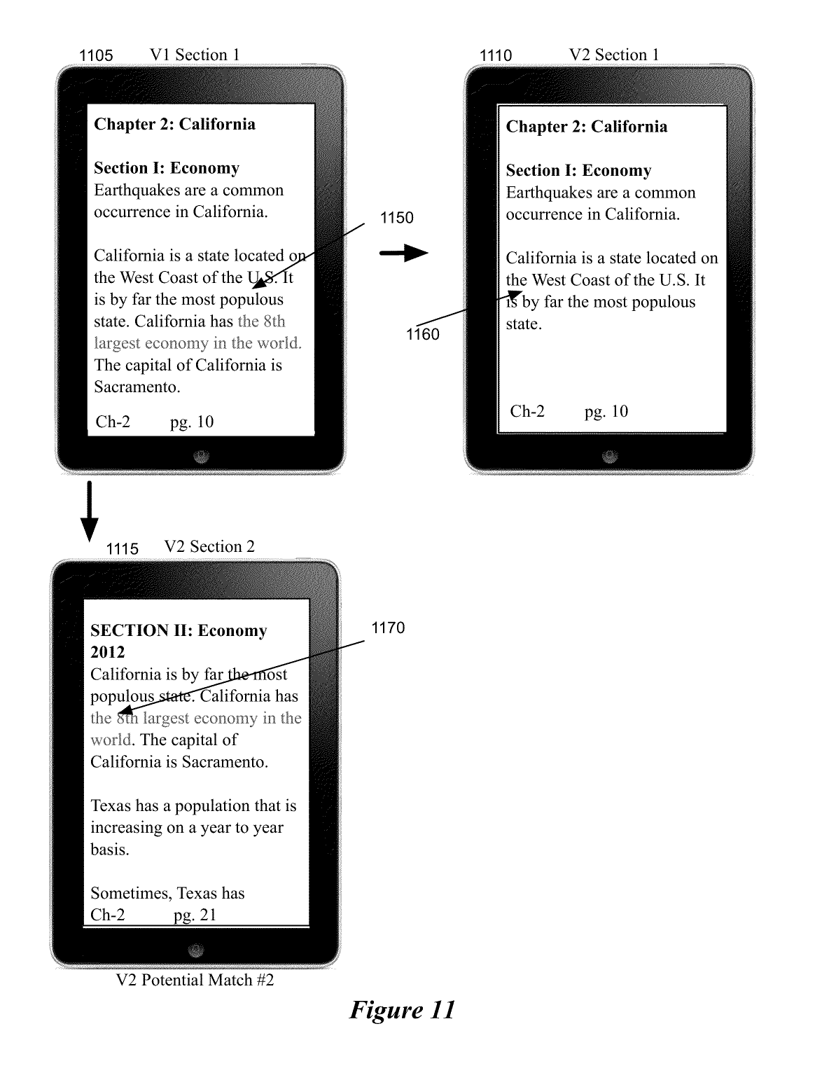

Returning to process 700 of FIG. 7, when the process does not detect (at 725) multiple matches at the expected section of a second version of a document, the process next determines (at 735) whether an exact unique match exists within a different section of the same chapter. As such, the process examines different sections within the chapter corresponding to the chapter in the first version that contains the annotation. When the process detects a single unique match within another section of the chapter, the process 700 incorporates (at 740) the annotation at the newly detected section within the chapter. FIG. 11 illustrates the situation in which the process does not detect a match within the expected section but does detect a match at a different section within the same chapter that contains the annotation.

FIG. 11 conceptually illustrates three views 1105-1115 that describe the operation of the annotation migration tool of the document viewer of some embodiments when an exact unique match has been detected within a different section of the same chapter. The first view 1105 displays a portion of a first version of a book, while the second and third views 1110-1115 display different portions of the same second version of the book. As shown in FIG. 11, the portion of the first version displayed in the first view 1105 is within Chapter 2 of the document. In this portion, the text “the 8^{th} largest economy in the world” has been highlighted as an annotation 1150.

The second view 1110 illustrates the second version of the document at the same expected location of the annotation 1150. As illustrated in the second view 1110, the word string 1160 that appears on page 10 of Chapter 2 in the second version, which is the same exact page and chapter as in the first version, now is devoid of any text regarding the California economy. Furthermore, the annotation migration tool has not detected any matching word strings within the section for the particular annotation.

The third view 1115 of FIG. 11 illustrates a matching word string 1170 in a different section of Chapter 2. In particular, “Section II: Economy 2012” contains matching text 1170. Given that the annotated text 1150 is identical to the particular text 1170 and that this is an exact unique match within the entire chapter, the annotation migration tool highlights the text 1170 despite appearing in a different section of the chapter in the second version.

Referring back to FIG. 7, when the process does not detect (at 735) an exact unique match in a different section of the chapter, the process determines (at 745) whether the expected section has been deleted from the second version of the book. In some embodiments, the process determines whether a chapter, and not just the section, has been deleted from the second version.

If the process 700 determines (at 745) that the expected section has not been deleted, the process incorporates (at 750) the annotations within a chapter-specific “Old Notes” section in the second version of the document. In this particular situation, the process has determined that no matching word string exists within the particular chapter of the second version of the document for the particular annotation, yet the second version still has the corresponding section of the document that was present in the first version of the document. Thus the process retains these annotations for the user within the same particular chapter of the document.

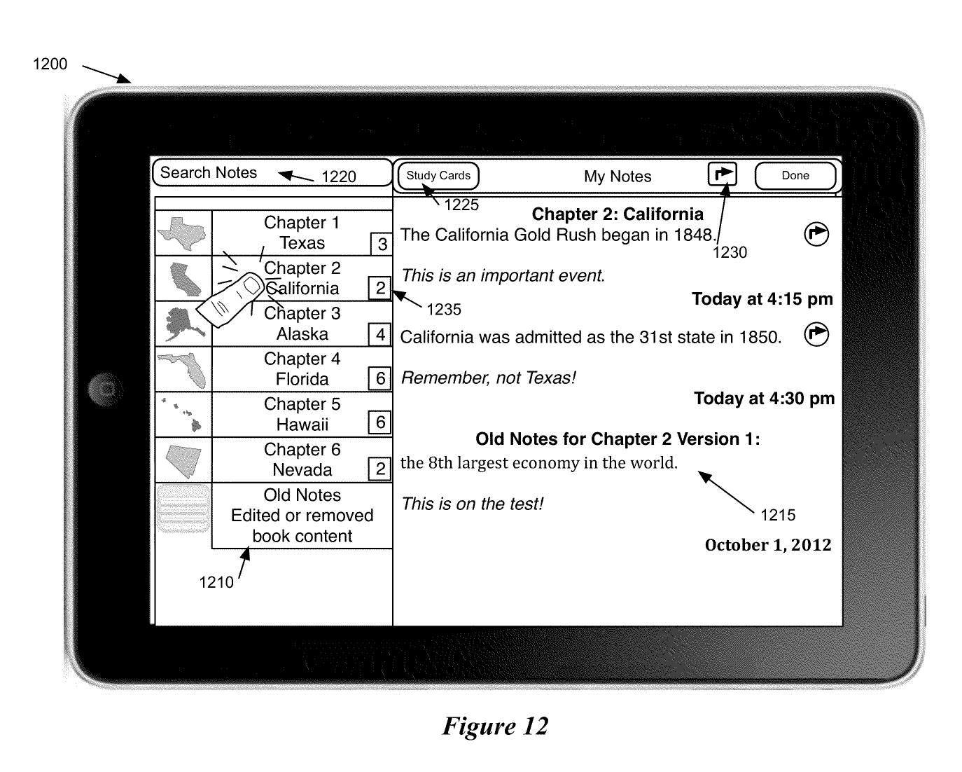

FIG. 12 illustrates an example of the chapter-specific old notes section in some embodiments. Specifically, FIG. 12 illustrates a user interface of the document viewer operating on a device 1200. The user interface displays various annotations, including highlights and the corresponding notes, that a user has made for a particular book. These annotations may have been migrated from a previous version of the book. The document viewer is displaying a graphical user interface (GUI) corresponding to the “notes” view of the document viewer. As shown in FIG. 12, the GUI includes a list of the different chapters 1210, annotations section 1215, search field 1220, and arrow icon 1230. The list of chapters 1210 includes entries for the chapters within the document. In some embodiments, the list 1210 displays only a subset of all chapters (e.g., a subset of entries that fit within the displayed GUI). The annotations section 1215 displays the highlighted text and the user's corresponding notes. Each highlighted text that was matched within a particular text in the document is listed in the top portion of the annotations section 1215. The bottom portion of the annotations section 1215 includes the chapter-specific old notes section, illustrated as “Old Notes for Chapter 2 Version 1” where the annotations that are not matched to word strings within the chapter are inserted. The search field 1220 allows a user to search within their annotations. The arrow icon 1230 switches the user interface back into the reading mode of the document viewer.

FIG. 12 illustrates the user selecting “Chapter 2 California” from the list of chapters of the book. The GUI also presents a number 1235 for each chapter that indicates the amount of highlights within the chapter. As indicated, Chapter 2 currently has two highlights of text within the document. The first highlighted text is “The California Gold Rush began in 1848” and the second highlighted text is “California was admitted as the 31^{st} state in 1850.” Furthermore, the notes view has included a section “Old Notes for Chapter 2 Version 1” which contains the highlight “the 8^{th} largest economy in the world” and the corresponding note “This is on the test!”. The document viewer places any annotations that it was unable to successfully match within a particular chapter of the second version within this particular “Old Notes for Chapter 2 Version 1” section. Each chapter contains this particular section when it has certain annotations that are not matched to a particular word string within the chapter.

Referring back to FIG. 7, the process 700 incorporates (at 750) the annotations within this chapter-specific old notes section when it determines that the expected section of the second version of the book has not been deleted, as well as all of the other considerations that the process examines when determining if and where to migrate a particular annotation within the second version of the document.

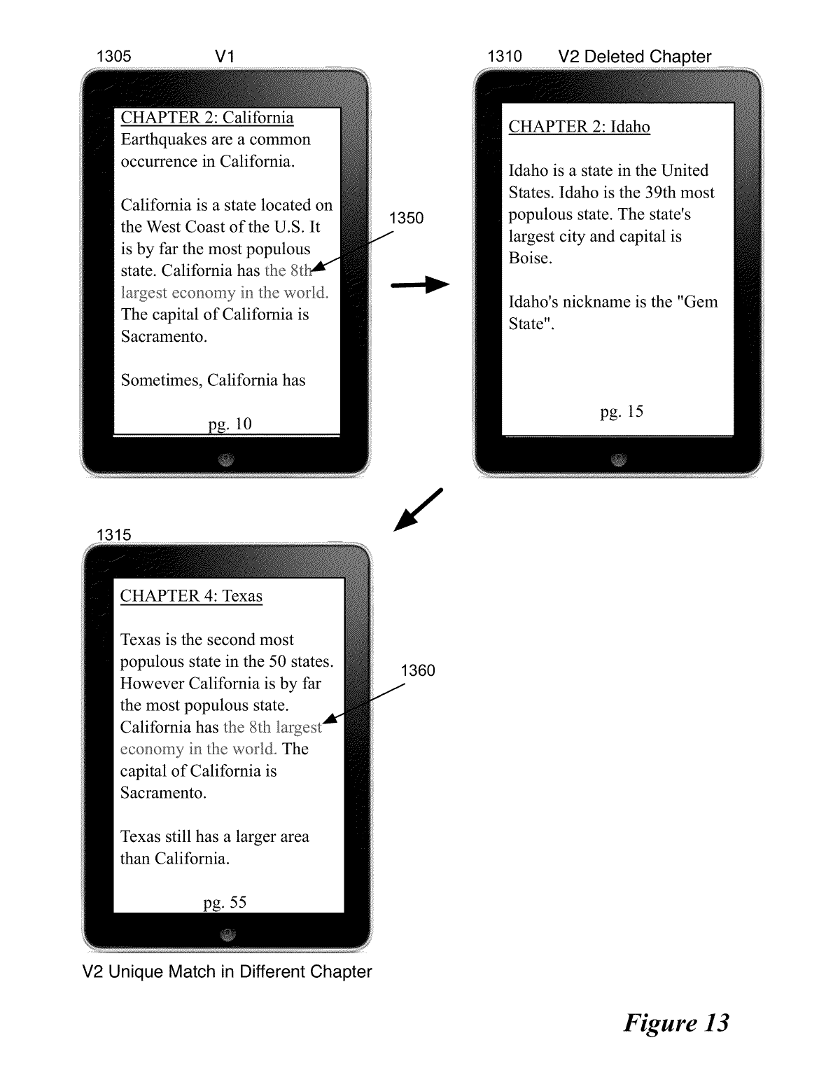

In some embodiments, if the process 700 determines (at 745) that the corresponding section has been deleted in the later version, it then uses (at 755) the words in the word string to derive a search string in some embodiments. In some embodiments, the process applies this search string to a search index in order to identify other chapters that have sections that might contain the search string. FIG. 13 illustrates the situation in which a particular chapter has been deleted from a second version of a book, but the process has identified a different chapter that contains the exact word string as the particular annotation being migrated from the first version of the document. FIG. 13 conceptually illustrates three views 1305-1315 that describe the operation of the annotation migration tool of the document viewer of some embodiments when a particular chapter in a second version of the document has been deleted. The first view 1305 displays a portion of a first version of a book, while the second and third views 1310-1315 display different portions of the same second version of the book. As shown in FIG. 13, the portion of the first version displayed in the first view 1305 is within Chapter 2 of the document. In this portion, the text “the 8^{th} largest economy in the world” has been highlighted as an annotation 1350. The second view 1310 illustrates the second version of the document with a different chapter than the first version. In particular, the second view displays “Chapter 2: Idaho” whereas the first version of the document displayed “Chapter 2: California”.

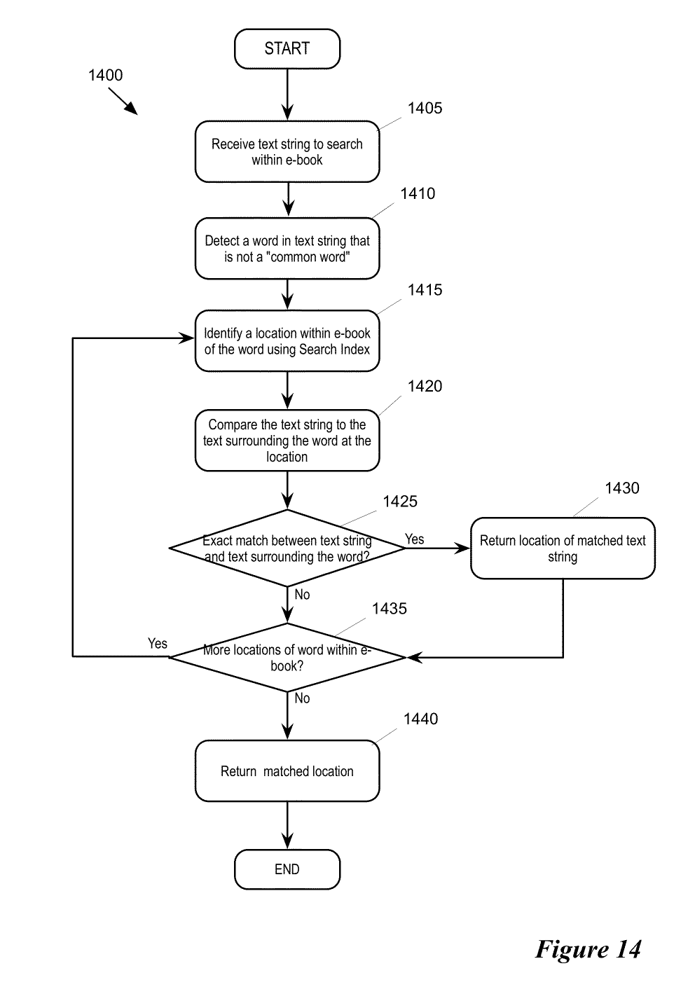

Referring back to FIG. 7, in this case, the process 700 has determined (at 760) that the expected section of the annotation has been deleted from the second version of the book. In particular, the process 700 has not detected the particular chapter on California in a different section of the book, (e.g., if the chapter had moved to a different location within the book). The process 700 of some embodiments could identify this new location by analyzing the annotation data structure to locate the chapter in the new version of the book, as described above by reference to FIG. 6. However, in this situation, the process 700 has determined that the chapter has been completely removed (e.g., the Storage ID is deleted, the Location ID indicates the chapter has been removed, and a search of the other areas of the book using the search index all indicate that the chapter is deleted). Thus the process 700 determines whether a unique exact match of the annotation word string appears in a different chapter within the second version of the document. In order to detect a matching word string in the second version of the document, the process 700 utilizes a search index, which is described in detail further below with reference to FIG. 14.

View 1315 of FIG. 13 illustrates a matching word string 1360 in Chapter 4 of the second version of the document. Given that the annotated text 1350 is identical to the particular text 1360 and that this is a unique match within the entire document, the annotation migration tool highlights the text 1360 despite appearing in a different chapter in the second version than the first version.

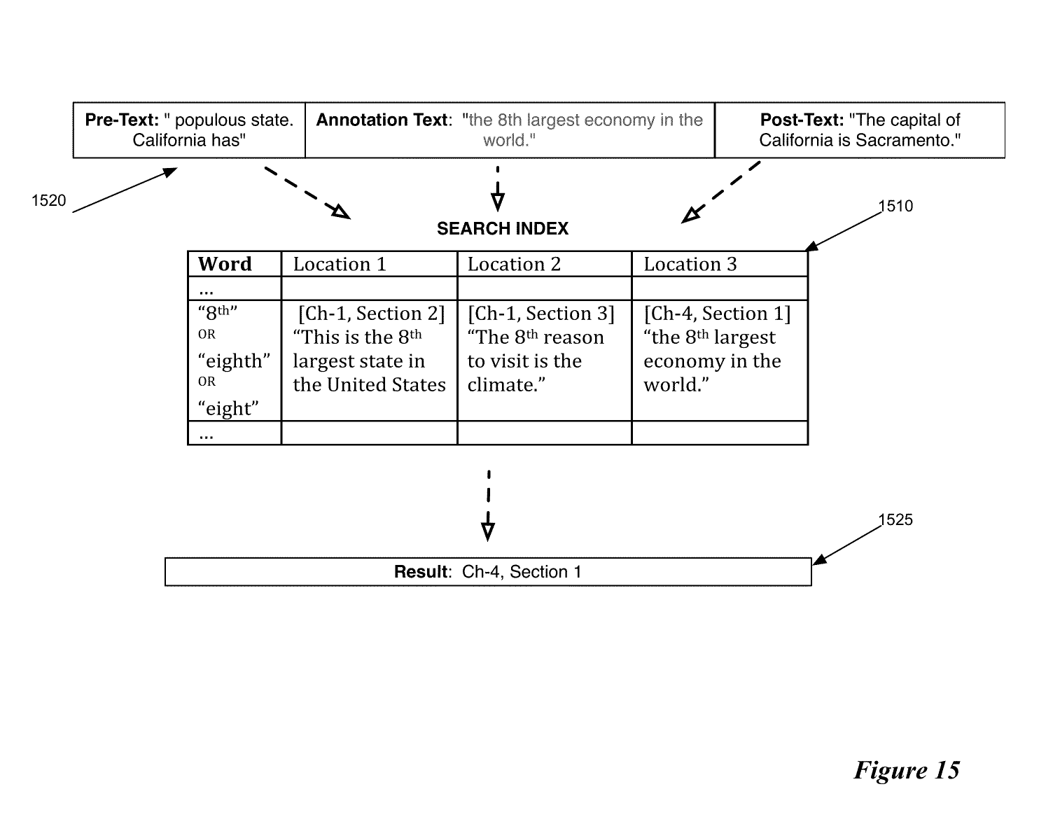

Rather than searching a document in a linear fashion (e.g., from the beginning to end), the annotation migration process in some embodiments utilizes a specialized search index to locate potential candidate word strings in various locations of the document. In some embodiments, the search index is a pre-compiled summary of the words that appear within the document along with an index of the corresponding location of the words within the document. In some embodiments, the search index is generated at the time that a particular version of a document is created. The search index may be later used by the document viewer to search for words and text throughout the document. FIG. 14 illustrates a process 1400 of some embodiments that use such a search index to locate a matching word string. Certain stages of the process 1400 will be described with reference to FIG. 15.

The process 1400 in some embodiments is performed by the annotation migration tool of the document viewer. The process 1400 initially receives (at 1405) an annotated word string to use as a search string to identify chapters in a different version that may contain a matching word. As mentioned above, the document viewer quickly identifies such chapters that contain some or all of the words in the search string. In other embodiments, the document viewer uses other schemes to specify when it should examine other sections and/or chapters for matching content segment sets. For example, in some embodiments, the document viewer not only uses the content segments (e.g., words) in the annotated content segment set (e.g., in the annotated word string) to identify a search string that is applied to a search index in order to identify the appropriate chapter or section for examination, but also uses the content segments (e.g., words) in the context to identify the search string. Also, in some embodiments, the document viewer examines other chapters or sections even when the section that contained the annotated content segment set is not deleted in the newer version of the document.

FIG. 15 illustrates a search index 1510 and a particular word search string 1520 that is to be searched using the search index 1510. The word string 1520 includes a pre-text string “populous state. California has”, the annotated text string “the 8^{th} largest economy in the world” and the post-text string “The capital of California is Sacramento.” This particular word string 1520 may be contained within an annotation data structure corresponding to a particular user highlight of text within a first version of a document.

Referring back to FIG. 14, the process 1400 next detects (at 1410) a word in the word string that is not a “common word”. Common words include simple words such as “the”, “a”, “where”, “there”, “he”, “she”, “it”, “and”, “they”, “who”, etc. These terms are likely to be in a multitude of locations within each individual chapter and thus are not included within the search index. When the process detects a word that is not a “common word”, the process (at 1415) identifies the location of the word within the document using a search index.

FIG. 15 illustrates that the annotation migration tool has determined that the first word within the annotation word string 1520 that is not a “common word” is the word “8^{th}”. In some embodiments, the tool examines the words within the annotation text of the word string 1520 prior to examining the words in the pre-text and post-text fields. The search index 1510 displays the various locations of the word “8^{th}” within the document. In particular, the term “8^{th}” appears in three different locations of the document. The first location is within Chapter 1, Section 2, the second location is within Chapter 1, Section 3, and the third location is within Chapter 4, Section 1.

When the process 1400 identifies (at 1415) the location of a word within the document, the process next compares (at 1420) the surrounding candidate text of the word to the annotated text to determine whether they match. If the process 1400 determines (at 1425) that the annotated text does not match the surrounding candidate surrounding, the process transitions to 1435. If the annotated text matches the surrounding candidate text, the process returns (at 1430) the location information of the identified word and then transitions to 1435.

In FIG. 15, the surrounding candidate text within the first location states “This is the 8^{th} largest state in the United States.” As this is not a match to the annotation word string 1520, the process determines (at 1435) if the search index 1510 indicates more locations of the word “8^{th}” within the document. If there are more locations, the process returns to 1415 to identify another location of the word within the document using the search index. In FIG. 15, the process continues examining the remaining locations, including Location 2 and Location 3. At Location 3, the process 1400 would detect a match for this particular candidate text located within Chapter 4, Section 1 for the annotation word string 1520. After the process 1400 has iterated through all of the locations in which the word appears within the document, the process returns (at 1440) the matched location(s). As illustrated in FIG. 15, the process returns a result 1525 of the matching candidate text within Chapter 4, Section 1 of the document.

In some embodiments, the process detects and examines (at 1410) multiple “uncommon” words in the annotation word string 1520 (including the pre-text and post text). For example, as illustrated in FIG. 15, the process 1400 would locate (at 1415) the words “largest” and “economy”, in addition to the word “8^{th}” using the search index 1510 and determine whether a particular location (e.g., a section, chapter, paragraph etc.) contained all three words. If the process 1400 detects a location that contains all three words in the word string 1520, the process would then (at 1420) compare the entire annotated word string 1520 (including the pre-text and post-text string) to the candidate text at the particular location to determine whether a match exists.

In some embodiments, the process detects the locations of every “uncommon” word within the annotated word string 1520 using the search index and only examines the locations that contain all of these words. For example, as illustrated in FIG. 15, the process would locate the locations of the words “populous”, “state”, “California”, “8^{th}”, “largest”, “economy”, “world”, “capital” and “Sacramento” using the search index. The process would then determine whether a particular location contained all of these words and only then would the process compare the entire annotated word string to the candidate text at this particular location.

Returning to FIG. 7, after the process 700 receives (at 755) the identified locations, it determines (at 760) whether any of the matched search strings are a unique match within the document. If the process 700 determines that there is a unique match within the document, the process incorporates (at 765) the annotation at the new location within the second version of the document. If the process 700 determines that there is no unique match, or that there are multiple matches within the different chapters of the document, the process then incorporates (at 770) the particular annotation into a “General Old Notes” section within the second version of the document.

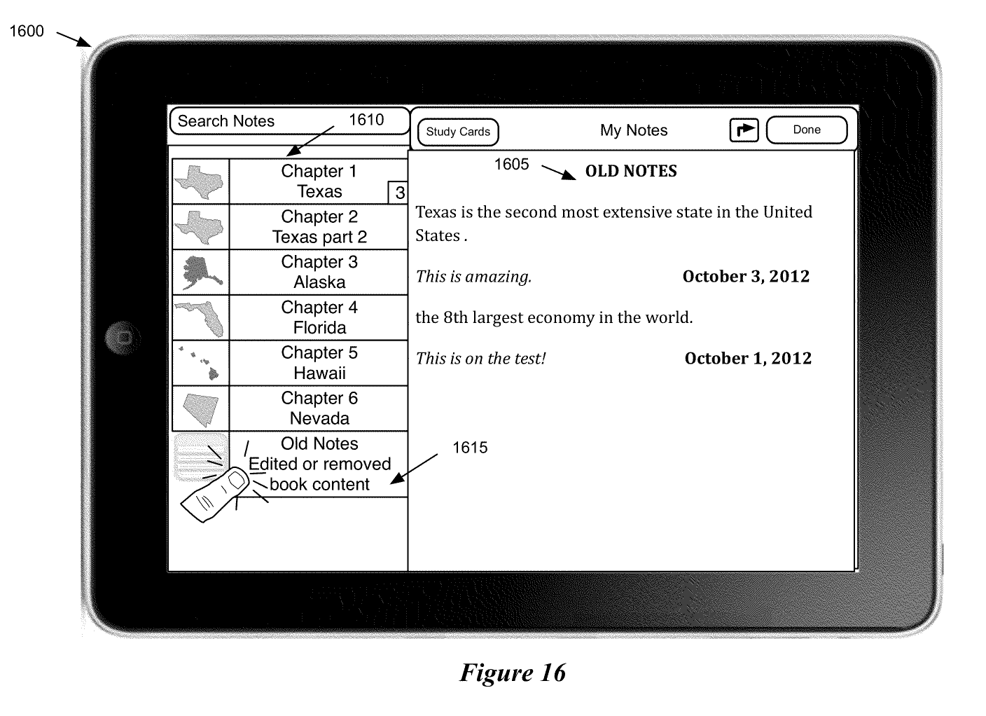

FIG. 16 illustrates a notes view 1600 and the “General Old Notes” section of the document viewer user interface, similar to that of FIG. 12 described above. The notes view 1600 is for displaying the various annotations, including highlights and the corresponding notes, that a user has made for a particular book. FIG. 16 also illustrates an “Old Notes” section 1605 of the user interface of the document viewer. As shown in FIG. 16, the display area includes a list 1610 of the different chapters within the document. Within the chapter section, there is an “Old Notes” icon 1615 that contains the “Edited or removed book content.” During the annotation migration process, any of the annotations from a first version of a document that could not be properly migrated to the corresponding location within the second version of the document will be placed within the general old notes section of the document.

FIG. 16 illustrates the user selecting the “Old Notes” icon 1615 and the display area displaying the “Old Notes” 1605 section which currently contains two user highlights with two corresponding notes that had been made within a prior version of the document. The first highlighted string states “Texas is the second most extensive state in the United States.” The corresponding note for this highlight states “This is amazing”. This particular annotation was created on Oct. 3, 2012. The second highlighted portion states “the 8^{th} largest economy in the world.” The corresponding note for this highlight states “This is on the test!” The document viewer places any annotations that it was unable to migrate to a particular word string or a particular chapter within the second version of the document within this general “Old Notes” section 1605. The general “Old Notes” section 1605 is different from the Chapter “Old Notes” section, illustrated in FIG. 12 above, because the annotations placed in the general “Old Notes” section 1605 have not been identified for even a particular chapter of the document. For example, a chapter in the first version may have been completely deleted in the second version.

Referring back to FIG. 7, the process 700 incorporates (at 770) the annotations within this general “Old Notes” section 1605 when it determines that there is no unique match of the annotation word string at any location within the entire document, in addition to all of the other considerations that the process examines when determining if and where to migrate a particular annotation within the second version of the document. After the process incorporates the annotations, the process ends. The specific operation of the process illustrated in FIG. 7 may not be performed in the exact order shown and described. The specific operations may not be performed in one continuous series of operations, and different specific operations may be performed in different embodiments.

As described above, in some embodiments the annotation migration tool automatically migrates annotations for a first version of a document to a second version of the document. In some embodiments, the process migrates all of the annotations when the document viewer opens the second version for the first time. As further described below, the migration tool in some embodiments performs this process in a background mode while a user is viewing a particular chapter within the second version of the document.

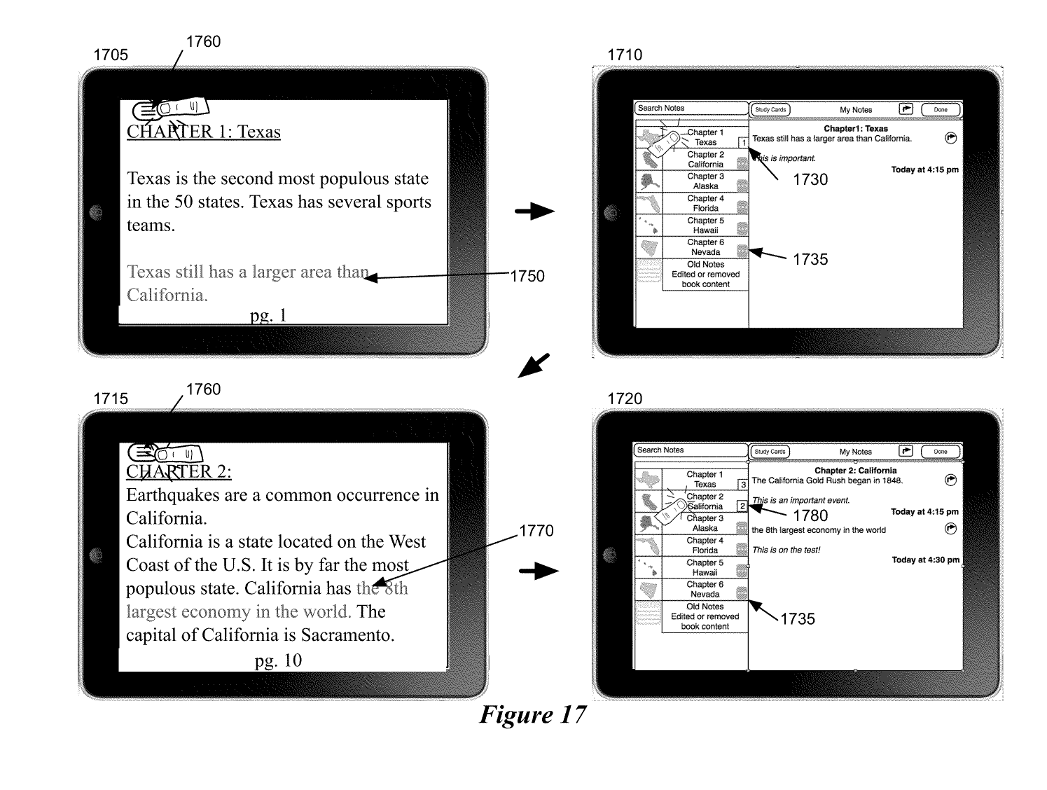

FIG. 17 illustrates the migration tool incrementally migrating a set of annotations into a second version of a document. FIG. 17 illustrates four stages 1705-1720 of this migration. In the first stage 1705 the document viewer displays a portion of a book. The portion of the book is page 1 of Chapter 1 of the document. In this portion, the text “Texas still has a larger area than California” has been highlighted as an annotation 1750. In the first stage 1705, the user is also selecting the “Notes” icon 1760 in order to view their annotations (highlights and notes) for this document.

The second stage 1710 illustrates that the document viewer now displays the notes user interface. The user interface includes the list of chapters within the document and the corresponding annotations for each chapter. The user interface currently indicates that there is one annotation 1730 for Chapter 1. The annotation for this chapter contains the highlighted word string “Texas still has a larger area than California” and the corresponding note “This is important.” Furthermore, an ellipsis (i.e., “ . . . ”) 1735 is shown for each of the remaining list of chapters. In some embodiments, an ellipsis 1735 is shown in lieu of a number because the number of annotations is not currently known. In this case, since the document viewer has only migrated the annotations from the first chapter of the document, the other chapters' annotations have not yet been migrated by the document viewer and, thus, the document viewer is not aware of the number of annotations within these chapters. In some embodiments, the document viewer migrates these annotations on an incremental (e.g., chapter by chapter, section by section, page by page) basis in order to optimize the performance of the device. This is particularly important on devices with limited resources (e.g., processing power, memory, battery life). In these embodiments, the document viewer only migrates those annotations within a particular portion of the document (e.g., portions that the user is viewing, or about to view on their device).

The third stage 1715 illustrates the document viewer displaying page 10 of Chapter 2 of the document. In this portion, the text “the 8^{th} largest economy in the world” has been highlighted as an annotation 1770 within this particular chapter of the document. The user is once again selecting the “Notes” icon 1760 in order to view the annotations (highlights and notes) within the document.

The fourth stage 1720 illustrates the document viewer displaying the notes user interface. The user interface now indicates two annotations 1780 for Chapter 2, in addition to three annotations 1730 for Chapter 1. The annotation for Chapter 2 contains the highlighted word string “the 8^{th} largest economy in the world” and the corresponding note word string “This is on the test!” Furthermore, the remaining list of chapters (Chapter 3-6) still display an ellipsis (i.e., “ . . . ”) 1735 for the number of annotations within the subsequent chapters. At this point, the document viewer has only migrated the annotations from the first and second chapters of the document.

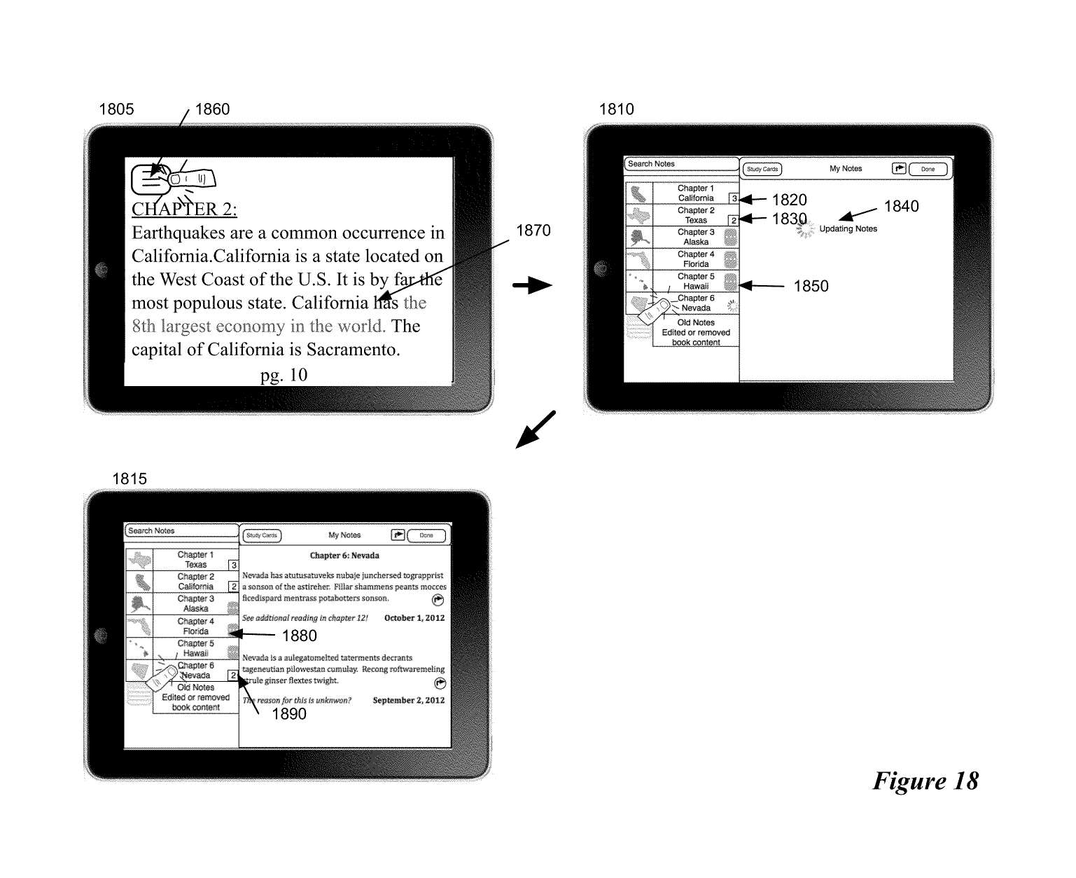

In some embodiments, the annotation migration process will only migrate the annotations from the chapter that the user is currently viewing. In other embodiments, the annotation migration process uses a priority queue and migrates first the annotations from the currently viewed chapter, and subsequently migrates the annotations from the other chapters in the background. In some embodiments, if the user skips several chapters to view a new different chapter, the annotation migration process skips those chapters as well and migrates the annotations from the new chapter. FIG. 18 illustrates the document viewer only migrating the annotations for a particular chapter. FIG. 18 illustrates three stages 1805-1815 of the document viewer when a user is viewing a particular chapter of a document while the document viewer is migrating annotations. In the first stage 1805, the document viewer displays a portion of a book. The portion of the book being displayed is page 10 in Chapter 2 of the document. The user is also selecting the “Notes” icon 1860 in order to view annotations (highlights and notes) within the document.

The second stage 1810 illustrates that the document viewer now displays the notes user interface. The notes user interface includes the list of chapters within the document and the corresponding annotations for each chapter. The user interface indicates that there are three annotations 1820 for Chapter 1 and two annotations 1830 for Chapter 2. The user interface also displays an ellipsis 1850 for Chapters 3-5. Furthermore, the user is selecting Chapter 6 to view the annotations. Since the user had not previously viewed Chapter 6, the document viewer has not migrated these annotations into the document. As such the document viewer displays an “Updating Notes” 1840 message to notify the user that the document viewer is currently synchronizing the annotations for this particular chapter within the document.

The third stage 1815 now illustrates the document viewer displaying the annotations for Chapter 6 of the document. This chapter currently contains two annotations 1890. Each annotation includes the highlighted word string within the document and the corresponding note. The document viewer has detected a matching word string within the document for each of these annotations, and thus has not placed them within the old notes section of the chapter. Furthermore, as the user skipped Chapters 3-5 and proceeded directly to Chapter 6 from Chapter 2, the annotations for Chapters 3-5 have not yet been incorporated into the document. As illustrated, Chapters 3-5 currently display ellipsis 1880 rather than a number to notify the user that these annotations have not yet been migrated.

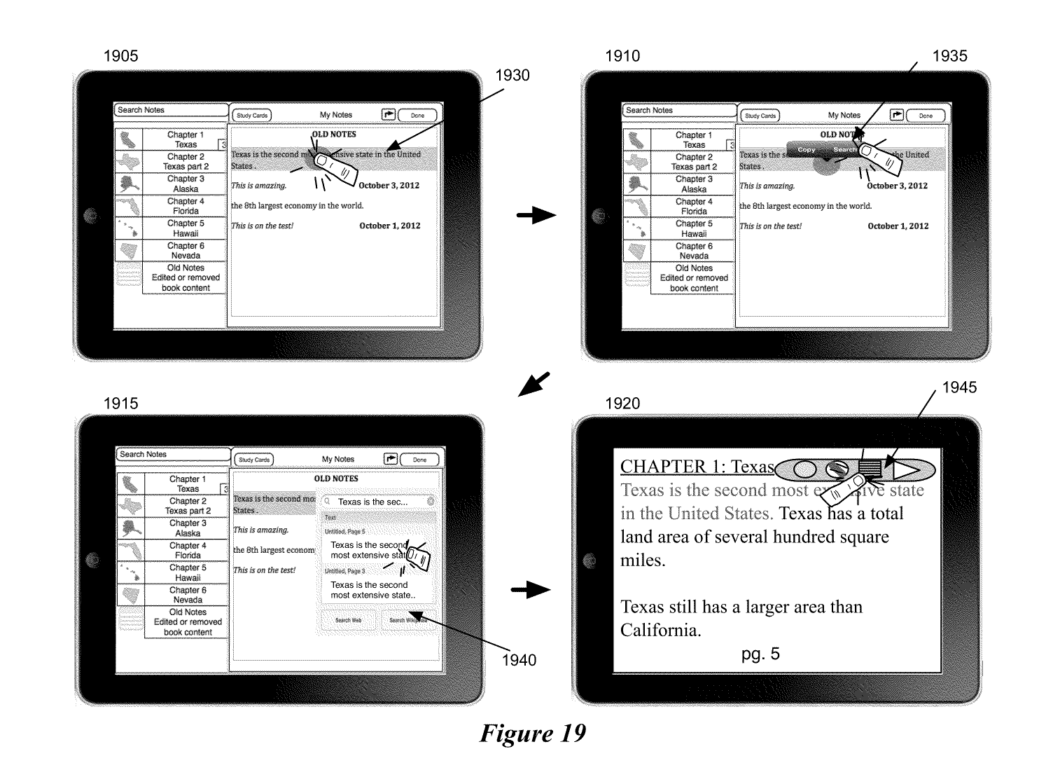

The notes user interface of the document viewer also provides the user with a variety of tools and features. The tools include the ability to search for a particular annotation within the entire document, the Internet, or Wikipedia. FIG. 19 illustrates in four stages 1905-1920 a user using the search tool to search a document based on a particular highlighted text.

The first stage 1905 illustrates a document viewer executing on a device. The document viewer is currently displaying the notes view of the application. The notes view provides a list of the chapters within the document as well as the annotations that have been made within each particular chapter. The user is currently viewing the “Old Notes” section that contains annotations that have been migrated from a previous version of the document, but that were not matched to any particular word string within the current version of the document. The Old Notes include two highlighted word strings with two corresponding notes. The first highlight contains the words “Texas is the second most extensive state in the United States.” The note corresponding to this highlight states “This is amazing.” Stage 1905 also illustrates the user selecting this particular highlighted annotation through a tapping gesture on the particular highlight. In some embodiments, after a user taps the highlight for a particular amount of time, the document viewer selects the particular annotation, as illustrated by the highlighting of the text 1930.

The second stage 1910 illustrates the document viewer now displaying a toolbar overlaid on the highlighted text string. The user is also selecting a “Search” icon 1935 that will cause the document viewer to search the document for all locations that contain the particular highlighted word string. Stage 1915 illustrates that the user interface now displays a popover toolbar 1940 overlaid on the notes view of the user interface. Within this popover toolbar 1940, a list of the locations that contain this particular word string is listed. The first location is on page 5 of the document and the second location is on page 3 of the document. The popover also gives the user the option to search the web for the particular word string or to search Wikipedia. Furthermore, a user may modify the particular word string by typing within the search field of the popover user interface. As illustrated, the user is selecting the word string located on page 5 of the document. Stage 1920 illustrates that the document viewer now displays page 5 of the document that contains the corresponding matching word string. Furthermore, the user has selected the word string to identify it as a highlighted annotation within the document. The user is about to select the “Notes” icon 1945 of the toolbar in order to add a note for the particular highlight.

In FIG. 19, the user has migrated notes from the general “Old Notes” section to an actual word string within Chapter 1 of the document. Furthermore, a user can review each note that the annotation migration process has determined does not contain an exact unique match within the document (and placed in the general “Old Notes” section or the chapter “Old Notes” section) and manually search and re-annotate these notes within the document. Additionally, in situations where there are multiple matching word strings within a document and, thus, the process has not selected any of the word strings, the user can select the appropriate word string using the above described steps to indicate the particular annotation.

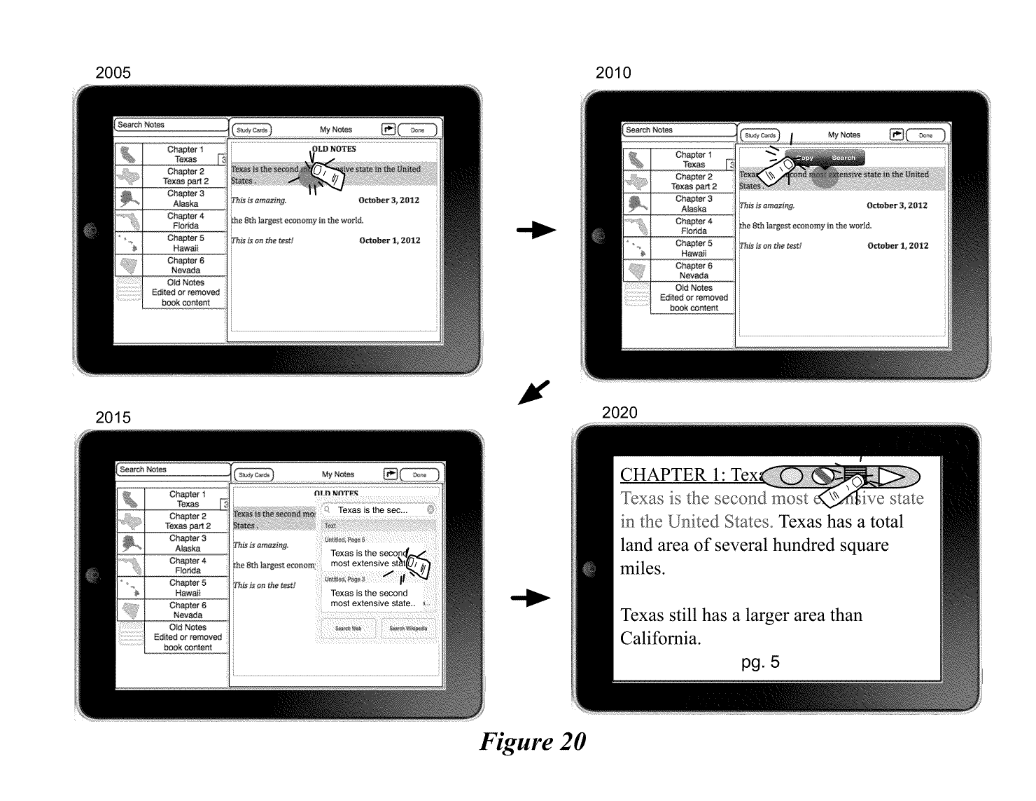

The notes view of the document viewer also provides the user with the ability to copy a particular annotation (either a highlighted portion of text or a corresponding note) and paste the annotation at various different locations. FIG. 20 illustrates four stages 2005-2020 of a user copying an annotation and pasting the annotation in a popover search tool.

The first stage 2005 illustrates the user tapping a particular annotation within their “Old Notes” which causes that particular annotation to be highlighted. The second stage 2010 illustrates the document viewer, in response to the user tapping on their “Old Notes”, displaying a toolbar overlaid on the highlighted text string. In this stage, the user is selecting a “Copy” icon (which is different from the “Search” icon that was selected in stage 1910 of FIG. 19). This allows a user to copy the annotation, including the particular highlight or note, and paste the annotation in a variety of locations (e.g., a search field, a word processing application, a web browser, etc.).

Stage 2015 illustrates that the user has pasted the annotation into the popover toolbar overlaid over the notes view of the user interface. Furthermore, this popover toolbar has listed various locations within the document that contain this particular highlight (e.g., word string). The first location is on page 5 of the document and the second location is on page 3 of the document. As illustrated, the user is selecting the word string located on page 5 of the document.

Stage 2020 illustrates that the document viewer now displays page 5 of the document that contains the corresponding matching word string. Furthermore, the user has selected the word string to identify it as a highlighted annotation within the document. The user is about to select the “Notes” icon in order to add a note for the particular highlight. This figure illustrates an alternative mechanism by which the user can search for a particular annotation within the document using the “Copy” icon.

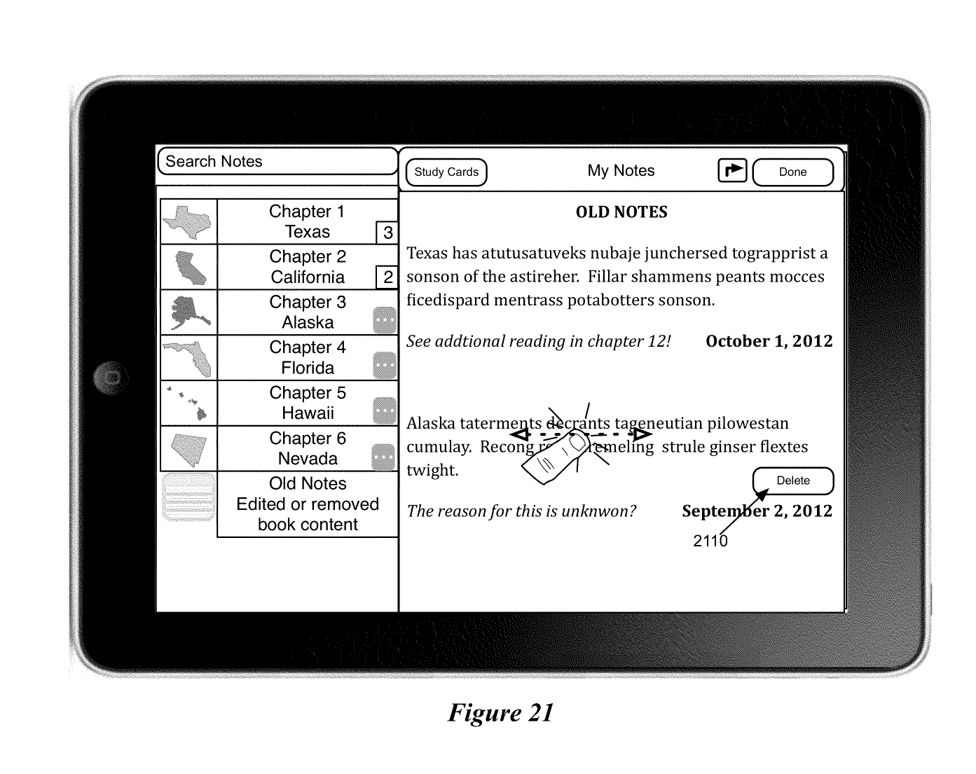

The notes view of the document viewer also permits a user to make a variety of edits to their particular annotations. These edits may include revising the notes associated with a particular highlight, searching for either the notes or highlight in a variety of locations (e.g., within the document, the Web, Wikipedia, etc.) Furthermore, a user may easily remove notes and or annotations from their document. FIG. 21 illustrates one mechanism by which a user may remove a particular annotation from the document. As illustrated, the document viewer is currently displaying the notes view of a particular document. The user is currently within their “Old Notes” section, which includes various notes from different versions of the document that have been migrated to this particular version of the document, but were not associated with any particular word string or chapter of the document. The Old Notes currently contain two highlight annotations and two corresponding notes for the annotations. Furthermore, the user is currently making a swiping gesture over a particular highlight annotation, which has caused a “delete” icon 2110 to appear. The user may select the delete icon 2110 to remove the highlight from the document. In some embodiments, deleting the highlight also removes the corresponding note of the highlight. In other embodiments, deleting the highlight does not delete the corresponding note.

As described above, the annotations within a document may also include, in addition to various highlights of text and notes, a user's set of bookmarks within a document. These bookmarks may include a set of user-specified bookmarks explicitly designated by the user, or certain implicit bookmarks that have been created by the document viewer on behalf of the user based on the user's last reading position within the document. During the annotation migration process, the document viewer migrates these annotations using the same process and annotation migration algorithm that has been described for migrating the annotations regarding a user's highlights and notes.

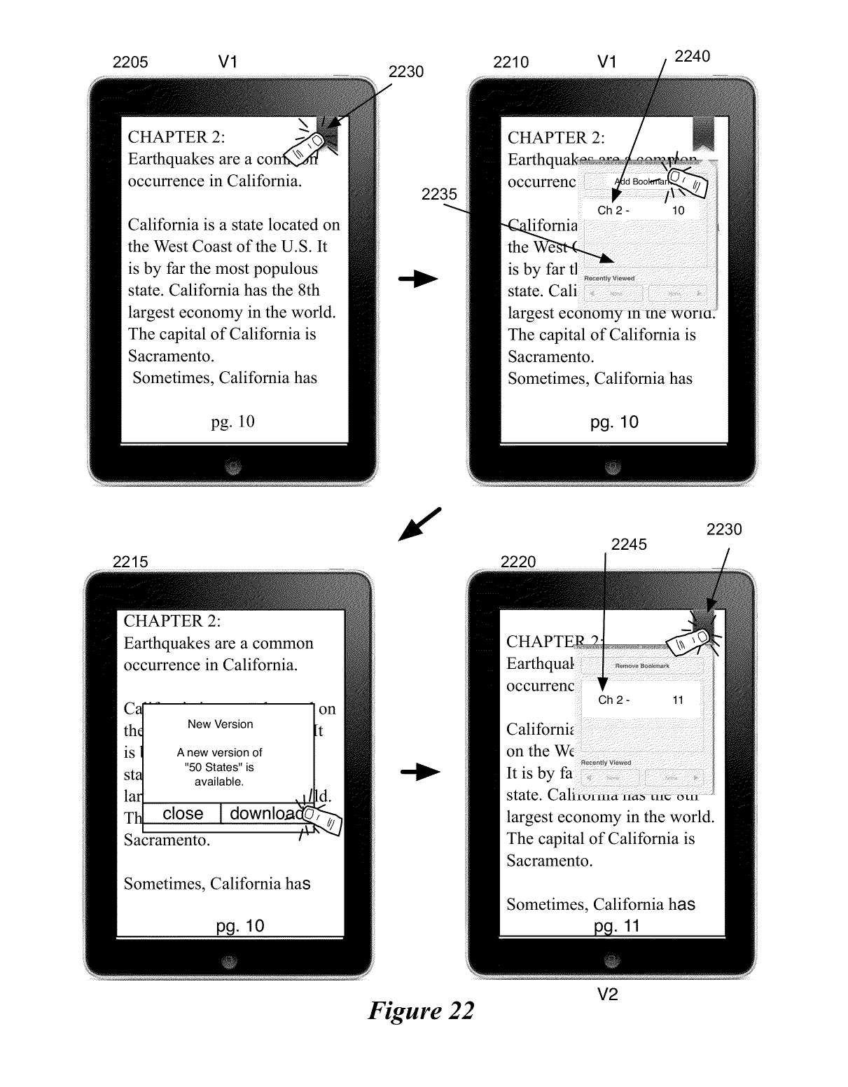

FIG. 22 illustrates four stages 2205-2220 in which the document viewer is migrating a user's bookmarks from a first version of a document to a second version of the document. The first stage 2205 illustrates the document viewer displaying a portion of a first version of a book in Chapter 2 of the document. The user is also selecting the bookmark icon 2230 on this particular portion of the document.

Stage 2210 illustrates that the bookmark toolbar 2235 is now displayed overlaid on the document. The user is also selecting the “Add Bookmark” icon in order to add a bookmark 2240 at the particular location of the document. The bookmark toolbar 2235 also provides the user with the ability to view certain recently viewed portions of the document.

Stage 2215 illustrates the user being notified that a new version of the particular document that the user is currently viewing has become available. In particular, the user is being notified that a new version of the book “50 States” is now available. The user is selecting to download this new version of the document. As illustrated, in some embodiments, the document viewer automatically notifies the user regarding updated versions of a particular document and allows the user to download the updates. The user may also access a content distribution system (e.g., iTunes®) to search for and obtain a particular version of a document. In some of these cases, the user's device automatically obtains a subsequent version of a document by accessing the content distribution system (e.g., iTunes®) without the user's input.

Stage 2220 illustrates that the user has now downloaded the new version of the document on the device. Furthermore, the user has selected the bookmark icon and is viewing a list of bookmarks for the particular document. The bookmark toolbar contains one bookmark 2245 that identifies a location of Chapter 2 of page 11 of the document. As such, the document viewer has migrated the user's bookmark 2240 from the first version of the document into the second version of the document. Furthermore, the document viewer has successfully identified that the corresponding location within the second version of the document is on page 11 of the document, which displays the beginning of Chapter 2. Even though the bookmark 2240 within the first version of the document was placed on page 10 of the document, the document viewer has successfully identified the proper location of the bookmark 2245 within the second version of the document, which is on page 11 of the document. The document viewer has identified the correct location to insert the particular bookmark using the same process and analysis described above in relationship to the migration of a user's highlight and notes annotations. In particular, the document viewer stores a variety of information for each particular bookmark that allows the document viewer to properly migrate these annotations between different versions of a document.

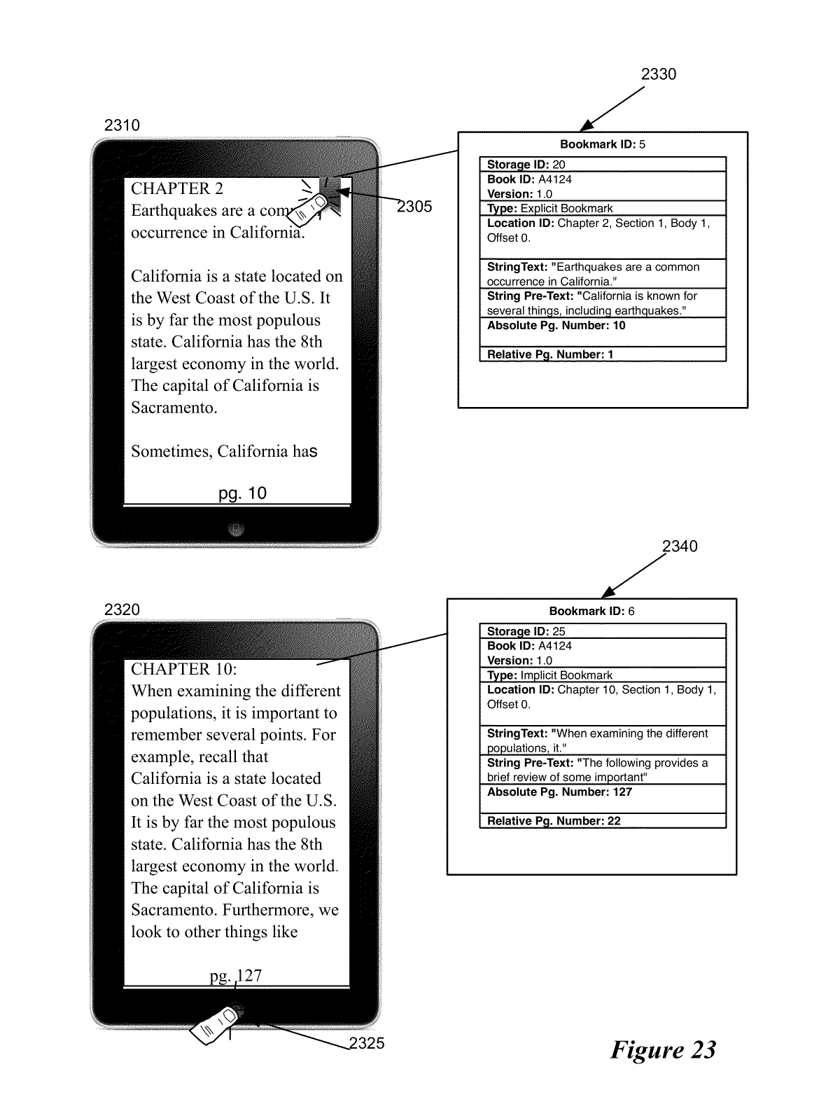

FIG. 23 illustrates the particular bookmark data structure that stores various information for each bookmark of a document. In some embodiments, the same types of information are stored for the bookmark data structure that are stored for the annotation data structures described above in FIG. 6, with some minor variations. This information is used by the document viewer during the annotation migration process in order to correctly migrate the annotations (e.g., bookmarks) from a first version of a document to a second version of the document.

A user may explicitly specify certain bookmarks or the document viewer may specify certain implicit bookmarks on behalf of the user. FIG. 23 illustrates two views 2310 and 2320 through which different types of bookmarks may be specified for a particular document and the corresponding bookmark data structures 2330-2340 for each type.

View 2310 illustrates a user creating an explicit bookmark within a document. In this view 2310, the document viewer is displaying Chapter 2, page 10 of the document. The user is also selecting the bookmark icon 2305 in order to create an explicit bookmark at this particular location of the document. The document viewer may also create certain implicit bookmarks on behalf of the user. View 2320 illustrates the document viewer automatically creating an implicit bookmark for the user upon the user closing out of the document viewer. As illustrated, the user is selecting button 2325 on the device, which closes out the document viewer. Upon closing the document, the document viewer automatically stores various information regarding the state and location of the user's particular reading position within the document at the time they closed out of the document.

The explicit user-specified bookmark and the implicit bookmark store various information that is used by the document viewer to correctly identify the correct location within the document for the particular bookmark. This information is stored within a bookmarks data structure for each bookmark. FIG. 23 illustrates the bookmark data structure 2330 that is created for the user-specified bookmark illustrated in view 2310 and the bookmark data structure 2340 that is created for the implicit bookmark illustrated in view 2320. Each bookmark data structure 2330 and 2340 contains the following fields, some of which are identical to fields described in FIG. 6, and some of which are modified for the bookmark data structure: A Bookmark ID, used to identify the particular bookmark from the set of bookmarks; A Storage ID, used to locate the correct storage node of the bookmark within the document tree structure; A Book ID, which identifies the particular document and the Version Number, which indicates the document's particular version number; A Type identification, which specifies whether this is a user-specified bookmark or an implicit bookmark specified by the document viewer; A Location ID which is identical to the Location ID described in FIG. 6 and identifies the exact location of the bookmark within the hierarchical tree structure of the document; A String Text field, which contains a word string of text on the current page of the document; A String Pre-Text field, which contains a word string of text on the preceding page of the document; An Absolute Page Number, which specifies the particular page of the entire document at which the bookmark was specified; and A Relative Page Number, which specifies the particular page within the section that the bookmark was specified. The relative page number is of particular importance when a document contains only images on the preceding page or pages of the document, and thus the String Pre-Text field of the bookmark is set to “null”. As described in the annotation migration process, the process uses the word strings within the annotation data structure to match the correct location within a document by comparing the word string to the text within the document. However, if a user specifies a bookmark on a page that contains only images, and thus no text data, then the document viewer may rely on the absolute and relative page numbers to correctly identify the location of the bookmark within the document.

For view 2310, the bookmark data structure 2330 contains the Bookmark ID “5”, the Storage ID “20”, the Book ID “A4124” with Version “1.0”. The Type is “Explicit Bookmark” since the user had explicitly inserted a bookmark in view 2310. The Location ID is Chapter 2, Section 1, Body 1, Offset 0, which corresponds to the particular portion of the document that is displayed in view 2310. The String Text field contains “Earthquakes are a common occurrence in California.” This word string is contained within the portion of the document displayed in view 2310. The String Pre-Text field contains the word string “California is known for several things, including earthquakes.” The document viewer has extracted certain text that is not displayed within view 2310, but that precedes the current portion of text being displayed. The document viewer uses both the word strings from the portions of the document that are currently displayed and word strings from the preceding text in order to correctly identify the exact position of the user's particular bookmark within the document. The Absolute Page Number is ten, which indicates this is the tenth page in the entire document and the Relative Page number is one, which indicates this is the first page of the particular chapter.

Bookmark data structure 2340 contains information corresponding to the bookmark created in view 2320. In particular, the Location ID contains Chapter 10, Section 1, Body 1, Offset 0, as the user was last viewing this particular portion, or chapter, of the document prior to closing out of the document. Furthermore, the Type field contains “Implicit Bookmark” to indicate this was automatically generated by the document viewer on behalf of the user to store the last reading position of the user prior the user closing out of the document. Furthermore, this bookmark data structure 2340 contains word strings from portions of text within the current page of the document, portions of text from the preceding page of the document, the absolute page number of the portion of text within the document, and the relative page number of the portion of text within the particular chapter of the document.

These bookmark data structures contain various information that is used by the document viewer to locate the exact location of the bookmark within the document. Furthermore, this information is essential during the annotation migration process and helps locate the correct locations to incorporate the bookmarks within a subsequent version of the document. By storing the various annotation and document information in the tree structure illustrated in FIG. 6, the document viewer can quickly migrate annotations between different versions of a document. The document viewer simply steps through the different annotation data structures and tries to identify content segment sets in the new version of the document that match the bookmark content segment sets that are identified in the data structure of the document's previous version.

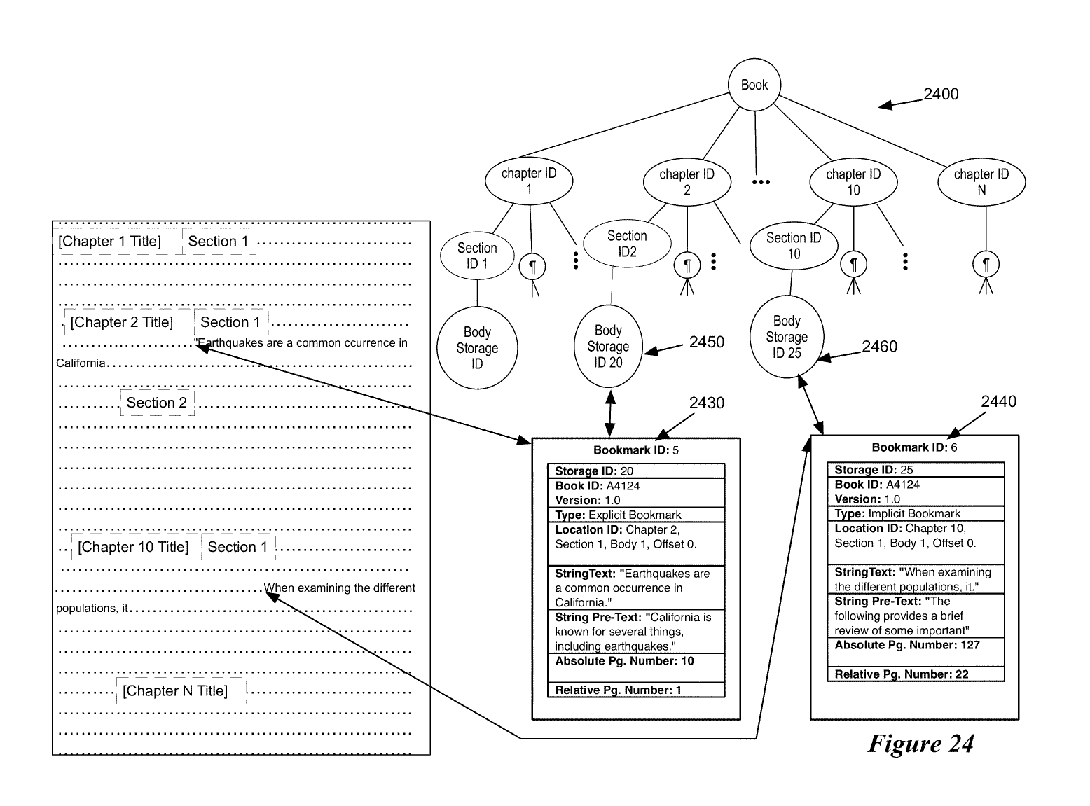

FIG. 24 conceptually illustrates the hierarchical tree structure 2400 of a structured electronic document and an example of the relationship between two bookmark data structures within the hierarchical tree 2400. The hierarchical data structure illustrated in FIG. 24 is the same tree structure described in detail in FIG. 6 although certain details of the tree structure have been left out for illustration purposes.

As described above, each particular location within the tree structure can be uniquely specified in terms of the Location ID (Chapter ID, Section ID, Body ID, and an Offset value) or through a Storage ID value, or using both the Location ID and Storage ID. The process identifies the particular storage through various mechanisms described above in detail in FIG. 6, including directly identifying the storage node using the unique Storage ID or using the Location ID to traverse down the hierarchical tree structure 2400, or both depending on the particular circumstances. Furthermore, each location of a particular bookmark can be specified using the absolute and relative page numbers within the document. The absolute and relative page numbers are especially important in situations where a user bookmarks a page that does not have any word strings, such as an image, or a page that comes after a page or several pages that contain only images. In this situation, the process does not have word strings within the bookmark data structure that it can use to correctly match the location within the hierarchical tree structure 2400 of a document. Therefore, the process examines the absolute and relative page number to correctly identify the location of the bookmark within the document.

As illustrated in FIG. 24, bookmark data structure 2430 is associated with (e.g., linked to) the body node 2450 and bookmark data structure 2440 is associated with the body node 2460. Each of these body nodes contains the particular location of the bookmark within the document. Different embodiments use different techniques to specify the starting location of each bookmark within the node (e.g., the starting word string to display for the bookmark location). For instance, some embodiments specify the starting content segment and ending content segment within the page of the document. Other embodiments specify the starting content segment set and an offset from which the identity of the ending content segment in the set can be derived. Yet other embodiments specify both the starting and ending content segments in a set in terms of two offset values, where the first one allows for the identification of the first content segment and the second one allows for the identification of the second content segment.

By storing the various information in each bookmark annotation data structure, the document viewer can quickly migrate these annotations between different versions of a document. The document viewer simply steps through the different annotation data structures and tries to identify locations in the new version of the document that match the location information identified in the annotation data structure of the document's previous version. The document viewer applies essentially the same process to the bookmark annotations that it uses for migrating other annotations (e.g., highlights and notes) described in detail above. For instance, in some embodiments, the viewer tries to identify the matching word string in a later version for each word string in the bookmark data structure for the earlier version by initially examining the body layer of the section in the later version that corresponds to the section in the earlier version with the particular word string. FIG. 7 described above provides further detail regarding the migration process for migrating annotations between different versions of a document.

In some embodiments, the document viewer disallows a user from migrating annotations to an earlier version of a book. For example, if a user currently has version 1 of a book on their device, and subsequently downloads version 2, all of the user's annotations will be migrated to version 2. However, if the user once again downloads version 1 of the document onto their device, the annotations that have been made within version 2 of the document will not be migrated back into version 1 of the document. This is disallowed primarily to avoid confusion regarding which set of annotations correspond to which version of a document.

Furthermore, for a user that is using a cloud service (e.g., iCloud®) to back up data from their device, once a user is viewing a particular version of a document on a device, only those annotations from the latest version of the document will be backed up to the user's cloud storage. FIG. 25 illustrates a user that has downloaded two different versions of a document on two different devices 2505 and 2510 of the user. The first device 2505 is displaying a portion of a first version of a document. The portion currently displays chapter 2 of the document and contains a highlight annotation 2550 of text that the user has highlighted. In particular, the highlighted text string is “California is a state located on the West Coast.” The same user's second device 2510 is displaying a portion of a second version of the same document being displayed on the user's first device 2505. However, the user has highlighted a different portion of text within the second version of the document. In particular the user has highlighted “the 8^{th} largest economy in the world.” The same highlight that appears in the first version of the user's device has been incorporated into the second version of the document, “California is a state located on the West Coast.” However, the first version of the device has not incorporated the user's highlight 2560 in the second version of “the 8^{th} largest economy in the world.” In some embodiments in which a user is backing up their annotation data with a cloud service (e.g., iCloud®), the cloud service stops synchronizing the annotations from an earlier version of a document once a user obtains a newer version of the document. This is illustrated in FIG. 25 by the large “X” 2570 placed over the cloud to indicate that the first device 2505 is no longer synchronized, or backing up any annotation data for the first version of the document from the user's first device to the cloud storage. However, the user's second device 2510 is still synchronized with the cloud service and all of the user's annotations within the second version of the document are still being backed up for their cloud service account.

Iii. Content Processor Modules

In some embodiments, the processes described above are implemented as software running on a particular machine, such as a computer or handheld device, or stored in a machine readable medium.

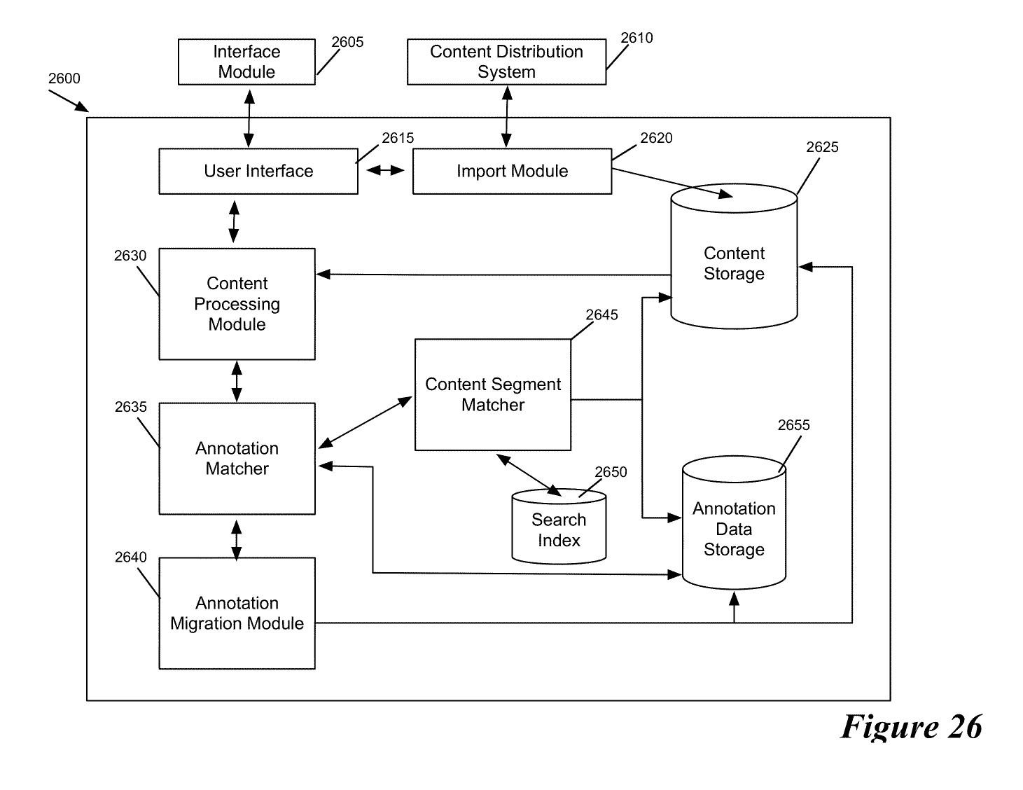

FIG. 26 conceptually illustrates the software architecture in some embodiments of a content processor 2600 that operates on a device. In some embodiments, the content processor 2600 is a document viewer that migrates annotations from a first version of content to a second version of content. For explanation purposes, the current version of the document that is to be displayed will be referred to as a second version of the document and the previous version of the document will be referred to as the first version of the document.

The content processor 2600 includes a user interface 2615, an import module 2620, a content processing module 2630, an annotation matcher 2635, an annotation migration module 2640, a content segment matcher 2645, a search index storage 2650, a content storage 2625 and an annotation data storage 2655. Also shown in FIG. 26 is an interface module 2605 that operates on the device to receive input from a user of the device. Also shown is a content distribution system 2610.

In some embodiments, the user interface 2615 interacts with the interface module 2605 to receive input regarding various annotations that are to be created and incorporated into a particular version of a document. In some embodiments, the input is user input that is received through a touch sensitive screen of the display of the device, or another input device (e.g., a cursor controller, such as a mouse, a touchpad, a trackpad, or a keyboard, etc.) In some embodiments, the user interface 2615 passes the user input received from the interface module 2605 to the content processing module 2630.

The import module 2620 is for importing content (e.g., documents, electronic books, etc.) from a content distribution system 2610 (e.g., iTunes®) and storing the content in the content storage 2625. An example of a content distribution system in some such embodiments is a third party content provider that receives content requests from the import module 2620 and provides the content to the import module 2620. In some embodiments, the import module 2620 receives automatic notifications from the content distribution system 2610 of newly available content. The import module 2620 of some such embodiments automatically downloads newly available content and stores the content in the content storage 2625. In other embodiments, the import module 2620 downloads newly available content in response to a user input that the user interface 2615 receives from the interface module 2605 and passes to the import module 2620. In some embodiments, the import module communicates with the user interface 2615 to automatically notify a user regarding newly available content (e.g., an updated version for a particular document). In these embodiments, the import module downloads the newly available content only in response to the user's input to do so. When the import module 2620 downloads newly available content in some embodiments the import module 2620 stores the content in the content storage 2625.

The content processing module 2630 receives requests from the user interface 2615 to display a particular document. The content processing module 2630 determines whether the document that is to be displayed has any previous versions within the content storage 2625. The content processing module 2630 displays the document to the user through the user interface 2615 when there are no previous versions. However, when there are previous versions associated the document, the content processing module communicates with the annotation matcher 2635 in order to migrate the annotations from the previous version into the current version.

The annotation matcher 2635 migrates all of the annotations from the first version of the document into the second version of the document. In some embodiments, the annotation matcher 2635 migrates all of the annotations into a document upon detecting that the import module 2620 has downloaded a new version of the document from the content distribution system 2610. In other embodiments, the annotation matcher 2635 incorporates the annotations on an incremental basis based on the particular portion of the second version that the user is viewing on their device. In order to migrate the annotations, the annotation matcher 2635 communicates with the content segment matcher 2645 and the annotation migration module 2640.

The content segment matcher 2645 identifies locations in the second version of the document at which to incorporate the annotations of the first version. In order to correctly identify the locations within the second version of the document, the content segment matcher 2645 analyzes each annotation stored in the annotation data storage 2655 for the first version of the document and identifies the corresponding location of the annotation within the second version of the document. After identifying a particular location within the second version of the document, the content segment matcher 2645 forwards this location information to the annotation matcher 2635 in order to create the annotation at the correct location within the second version of the document. In some embodiments, the content segment matcher 2645 uses a search index storage 2650 to identify the corresponding location within the second version of the document for a particular annotation. In some embodiments, the content segment matcher 2645 only uses the search index storage 2650 in situations where the content segment matcher detects that a deleted section of the second version corresponds to a section that contains a particular annotation in the first version of the document. In other embodiments, the content segment matcher uses the search index when the content segment matcher is searching within the second version of the document. For example, the content segment matcher may use the search index 2650 to search other sections within a particular chapter in a second version of the document that corresponds to a chapter that contains the annotation in the first version of the document.

The search index storage 2650 stores a compiled word index of all of the words within the document and a corresponding location index of the location(s) of the word within the document. Certain words are excluded from the word index, including “common words” such as “the”, “a”, “where”, “there”, “he”, “she”, “it”, “and”, “they”, “who”, etc. The search index storage 2650 in some embodiments is compiled at the time the document is received by the import module 2620. In other embodiments, the search index storage 2650 is compiled as individual words are searched within the document (e.g., on the fly).

The annotation migration module 2640 initializes the annotation data structure for each annotation that is incorporated into the second version of the document. In some embodiments, the annotation migration module 2640 creates a new annotation data structure for each annotation in the second version of the document. In other embodiments, the annotation migration module 2640 modifies the annotation data within the annotation data structure of the first version of the document to correlate with the second version of the document. The annotation migration module stores the annotations in the annotation data storage 2655.

The annotation data storage 2655 stores the annotation data structure for each annotation in different versions of different documents. Each annotation data structure contains various information regarding the annotation, including the location of the annotation within the particular version of the document (e.g., Storage ID, Chapter ID, Section ID, Offset), the word strings within the document that correspond to the annotation (e.g., highlighted text), and the document information associated with the annotation (e.g., book ID number, version number).

The content storage 2625 stores various content (e.g., documents) received from the import module 2620. In some embodiments, the content storage 2625 stores different versions of a single document. In other embodiments, the content storage deletes a first version of the document when it receives a second version of the document from the import module 2620.

The operation of the content process 2600 will now be described for the case the content processing module 2630 is opening a new version of a document for which it has stored an older version with annotations. The content processing module initially receives from the user interface 2615 a request to display a particular document. The content processing module retrieves the requested document from the content storage 2625. If the content processing module also detects that the content storage contains a previous version of the document, the content processing module 2630 next determines whether the annotation data from the previous version of the document has been incorporated into the new version of the document. For explanation purposes, the previous version is referred to as a “first version” and the current version of the document is referred to as a “second version” of the document. When the content processing module determines that the annotation data from the first version has not been incorporated into the second version, the content processing module notifies the annotation matcher 2635 to begin migrating the annotations from the first version into the second version.

The annotation matcher 2635 retrieves all of the annotation data from the annotation data storage 2655 for the first version of the document. For each annotation in the annotation data, the annotation matcher 2635 extracts the annotation data structure for the annotation. The annotation matcher 2635 forwards the annotation data structure to the content segment matcher 2645. As described above, the annotation data structure includes the location of the annotation within the first version of the document (e.g., Storage ID, Chapter ID, Section ID, Offset), the content of the annotation (e.g., the highlighted content segments, the surrounding text of the highlight), and certain document-specific information including the particular version of the document in which the annotation was created.

The content segment matcher 2645 identifies and analyzes, using the location information within the annotation data structure, the particular section in the second version that corresponds to the section that contains the annotation in the first version.

When the content segment matcher 2645 detects that the section has been deleted in the second version of the document, the content segment matcher 2645 uses the search index storage 2650 to identify the location of other matching word strings in the entire document. The content segment matcher 2645 extracts a search string corresponding to the word string within the annotation data structure and applies each word in the search string to the word index within the search index storage 2650. The content segment matcher 2645 identifies the first word in the search string that is not a “common word” (e.g., “the”, “a”, “an”, etc.). The content segment matcher identifies, using the word index and corresponding location within the search index storage 2650, each location of the word within the second version of the document. For each identified location, the content segment matcher determines whether the entire search string matches the text within the particular location. Furthermore, the content segment matcher determines whether there is a unique match within the second version of the document. If the content segment matcher 2645 detects a unique match at a particular location, the content segment matcher 2645 forwards this location information to the annotation matcher 2635. If the content segment matcher 2645 does not detect a unique match in the entire document, the content segment matcher 2645 notifies the annotation matcher 2635 that no matching word strings exist within the entire document.

When the content segment matcher 2645 detects that the particular section has not been deleted in the second version of the document, the content segment matcher 2645 analyzes the word strings at the exact location (e.g., same offset within the Section ID or Storage ID) of the second version that corresponds to the annotation's location (e.g., offset within the Section ID or Storage ID) in the first version. When the content segment matcher 2645 identifies a matching word string, the content segment matcher forwards the location information (e.g., Storage ID, Chapter ID, Section ID, and Offset) to the annotation matcher 2635. When the content segment matcher 2645 does not identify a matching word, the content segment matcher searches within the same section (e.g., Storage ID or Section ID) to identify a matching word string. When the content segment matcher 2645 identifies a matching word string within the same section that is closest to the annotation of the first version, the content segment matcher 2645 forwards this location information (e.g., Storage ID, Chapter ID, Section ID and Offset) to the annotation matcher 2635.

When the content segment matcher 2645 does not identify a matching word string in the same section of the chapter, the content segment matcher examines the other sections within the same chapter for a matching word string (e.g., Chapter ID). If the content segment matcher 2645 detects a unique matching word string in a different section of the same chapter, the content segment matcher forwards the location information to the annotation matcher 2635. If the content segment matcher 2645 does not detect a matching word string in a different section of the same chapter, the content segment matcher 2645 informs the annotation matcher 2635 that no matching word string exists within the chapter.

As described above, the annotation matcher 2635 receives from the content segment matcher 2645 the location information (e.g., Storage ID, Chapter ID, Section ID, Offset) in the second version at which to incorporate an annotation of the first version of the document. In some embodiments, the annotation matcher 2635 uses the annotation migration module 2640 to migrate the annotation into the second version of the document. The annotation migration module 2640 receives the location information and creates an annotation data structure that includes the particular location information, the corresponding matching word string, and the document information. The annotation migration module stores this annotation data structure within the annotation data storage 2655. The annotation migration module also links the annotation data structure to the particular version of the document stored in the content storage 2625.

In some embodiments, the content segment matcher 2645 uses the search index storage 2650 to search the document even when the particular section has not been deleted in the second version. In particular, the content segment matcher examines a particular section in the second version of the document that corresponds to the section that contains the annotation in the first version. If the section has been deleted or does not contain a matching word string, the content segment matcher 2645 uses the search index 2650, described above, to immediately identify other sections (e.g., Storage IDs) within the document that contain a word string that matches the annotation.

After each annotation has been incorporated into the second version of the document, the annotation matcher 2635 informs the content processing module 2630 that all of the annotations from the first version of the document have been incorporated into the second version of the document. The content processing module 2630 then displays to the user, through the user interface 2615 the second version of the document showing the incorporated annotation data.

Iv. Electronic Systems

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

A. Mobile Device

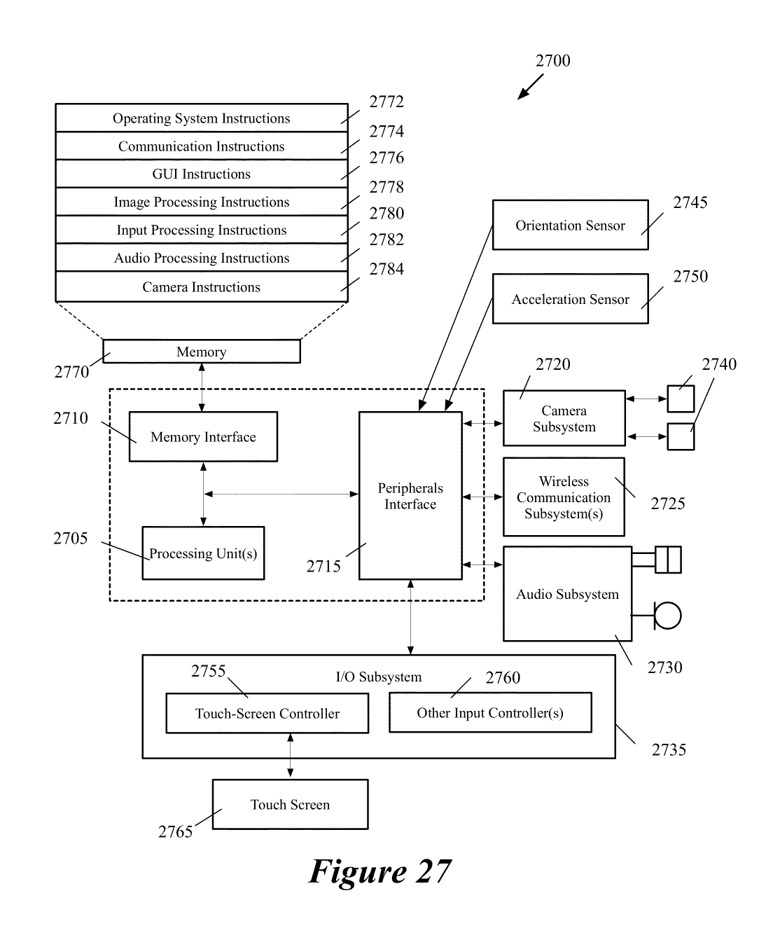

The content processing applications of some embodiments operate on mobile devices. FIG. 27 is an example of an architecture 2700 of such a mobile computing device. Examples of mobile computing devices include smartphones, tablets, laptops, etc. As shown, the mobile computing device 2700 includes one or more processing units 2705, a memory interface 2710 and a peripherals interface 2715.

The peripherals interface 2715 is coupled to various sensors and subsystems, including a camera subsystem 2720, a wireless communication subsystem(s) 2725, an audio subsystem 2730, an I/O subsystem 2735, etc. The peripherals interface 2715 enables communication between the processing units 2705 and various peripherals. For example, an orientation sensor 2745 (e.g., a gyroscope) and an acceleration sensor 2750 (e.g., an accelerometer) is coupled to the peripherals interface 2715 to facilitate orientation and acceleration functions.

The camera subsystem 2720 is coupled to one or more optical sensors 2740 (e.g., a charged coupled device (CCD) optical sensor, a complementary metal-oxide-semiconductor (CMOS) optical sensor, etc.). The camera subsystem 2720 coupled with the optical sensors 2740 facilitates camera functions, such as image and/or video data capturing. The wireless communication subsystem 2725 serves to facilitate communication functions. In some embodiments, the wireless communication subsystem 2725 includes radio frequency receivers and transmitters, and optical receivers and transmitters (not shown in FIG. 27). These receivers and transmitters of some embodiments are implemented to operate over one or more communication networks such as a GSM network, a Wi-Fi network, a Bluetooth network, etc. The audio subsystem 2730 is coupled to a speaker to output audio (e.g., to output different sound effects associated with different image operations). Additionally, the audio subsystem 2730 is coupled to a microphone to facilitate voice-enabled functions, such as voice recognition, digital recording, etc.

The I/O subsystem 2735 involves the transfer between input/output peripheral devices, such as a display, a touch screen, etc., and the data bus of the processing units 2705 through the peripherals interface 2715. The I/O subsystem 2735 includes a touch-screen controller 2755 and other input controllers 2760 to facilitate the transfer between input/output peripheral devices and the data bus of the processing units 2705. As shown, the touch-screen controller 2755 is coupled to a touch screen 2765. The touch-screen controller 2755 detects contact and movement on the touch screen 2765 using any of multiple touch sensitivity technologies. The other input controllers 2760 are coupled to other input/control devices, such as one or more buttons. Some embodiments include a near-touch sensitive screen and a corresponding controller that can detect near-touch interactions instead of or in addition to touch interactions.

The memory interface 2710 is coupled to memory 2770. In some embodiments, the memory 2770 includes volatile memory (e.g., high-speed random access memory), non-volatile memory (e.g., flash memory), a combination of volatile and non-volatile memory, and/or any other type of memory. As illustrated in FIG. 27, the memory 2770 stores an operating system (OS) 2772. The OS 2772 includes instructions for handling basic system services and for performing hardware dependent tasks.

The memory 2770 also includes communication instructions 2774 to facilitate communicating with one or more additional devices; graphical user interface instructions 2776 to facilitate graphic user interface processing; image processing instructions 2778 to facilitate image-related processing and functions; input processing instructions 2780 to facilitate input-related (e.g., touch input) processes and functions; audio processing instructions 2782 to facilitate audio-related processes and functions; and camera instructions 2784 to facilitate camera-related processes and functions. The instructions described above are merely exemplary and the memory 2770 includes additional and/or other instructions in some embodiments. For instance, the memory for a smartphone may include phone instructions to facilitate phone-related processes and functions. The above-identified instructions need not be implemented as separate software programs or modules. Various functions of the mobile computing device can be implemented in hardware and/or in software, including in one or more signal processing and/or application specific integrated circuits.

While the components illustrated in FIG. 27 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that the functions described with respect to FIG. 27 may be split into two or more integrated circuits.

B. Computer System

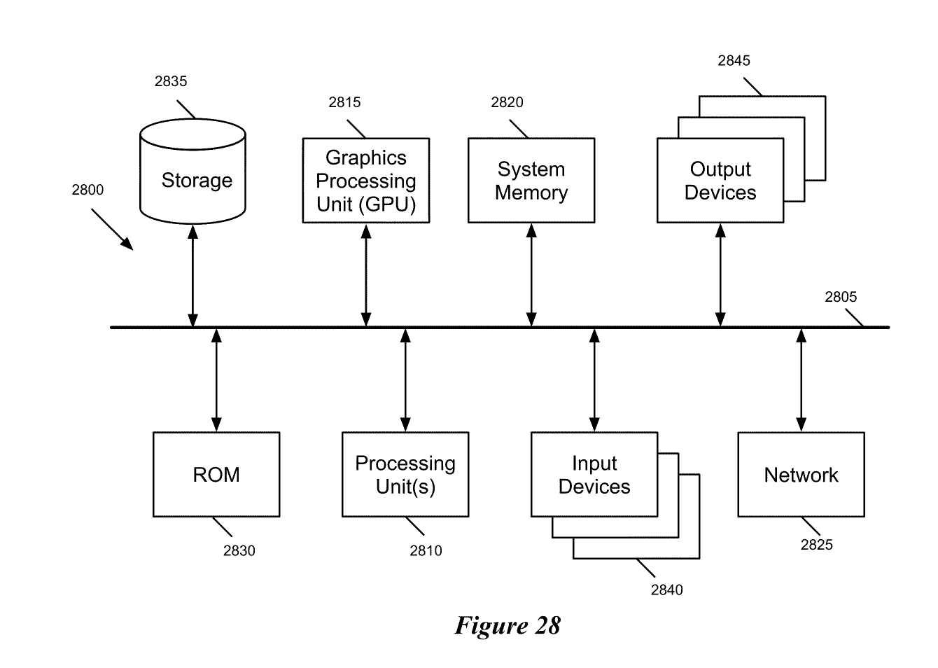

FIG. 28 conceptually illustrates another example of an electronic system 2800 with which some embodiments of the invention are implemented. The electronic system 2800 may be a computer (e.g., a desktop computer, personal computer, tablet computer, etc.), phone, PDA, or any other sort of electronic or computing device. Such an electronic system includes various types of computer readable media and interfaces for various other types of computer readable media. Electronic system 2800 includes a bus 2805, processing unit(s) 2810, a graphics processing unit (GPU) 2815, a system memory 2820, a network 2825, a read-only memory 2830, a permanent storage device 2835, input devices 2840, and output devices 2845.

The bus 2805 collectively represents all system, peripheral, and chipset buses that communicatively connect the numerous internal devices of the electronic system 2800. For instance, the bus 2805 communicatively connects the processing unit(s) 2810 with the read-only memory 2830, the GPU 2815, the system memory 2820, and the permanent storage device 2835.

From these various memory units, the processing unit(s) 2810 retrieves instructions to execute and data to process in order to execute the processes of the invention. The processing unit(s) may be a single processor or a multi-core processor in different embodiments. Some instructions are passed to and executed by the GPU 2815. The GPU 2815 can offload various computations or complement the image processing provided by the processing unit(s) 2810. In some embodiments, such functionality can be provided using Corelmage's kernel shading language.

The read-only-memory (ROM) 2830 stores static data and instructions that are needed by the processing unit(s) 2810 and other modules of the electronic system. The permanent storage device 2835, on the other hand, is a read-and-write memory device. This device is a non-volatile memory unit that stores instructions and data even when the electronic system 2800 is off. Some embodiments of the invention use a mass-storage device (such as a magnetic or optical disk and its corresponding disk drive) as the permanent storage device 2835.

Other embodiments use a removable storage device (such as a floppy disk, flash memory device, etc., and its corresponding drive) as the permanent storage device. Like the permanent storage device 2835, the system memory 2820 is a read-and-write memory device. However, unlike storage device 2835, the system memory 2820 is a volatile read-and-write memory, such a random access memory. The system memory 2820 stores some of the instructions and data that the processor needs at runtime. In some embodiments, the invention's processes are stored in the system memory 2820, the permanent storage device 2835, and/or the read-only memory 2830. For example, the various memory units include instructions for processing multimedia clips in accordance with some embodiments. From these various memory units, the processing unit(s) 2810 retrieves instructions to execute and data to process in order to execute the processes of some embodiments.

The bus 2805 also connects to the input and output devices 2840 and 2845. The input devices 2840 enable the user to communicate information and select commands to the electronic system. The input devices 2840 include alphanumeric keyboards and pointing devices (also called “cursor control devices”), cameras (e.g., webcams), microphones or similar devices for receiving voice commands, etc. The output devices 2845 display images generated by the electronic system or otherwise output data. The output devices 2845 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 28, bus 2805 also couples electronic system 2800 to a network 2825 through a network adapter (not shown). In this manner, the computer can be a part of a network of computers (such as a local area network (“LAN”), a wide area network (“WAN”), or an Intranet, or a network of networks, such as the Internet. Any or all components of electronic system 2800 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. For instance, many of the figures illustrate various touch gestures (e.g., taps, double taps, swipe gestures, press and hold gestures, etc.). However, many of the illustrated operations could be performed via different touch gestures (e.g., a swipe instead of a tap, etc.) or by non-touch input (e.g., using a cursor controller, a keyboard, a touchpad/trackpad, a near-touch sensitive screen, etc.). In addition, a number of the figures (including FIGS. 5, 7, and 14) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

We claim:

1. A machine readable medium storing a program for displaying a document having first and second versions that respectively comprise first and second pluralities of content segments, the first version further comprising at least one annotation specified for at least a first set of content segments, the program comprising sets of instructions for:
examining different sets of content segments in the second version to identify a particular set of content segments that matches the first set of content segments; and
upon identifying a matching particular content segment set, associating the particular annotation with the particular content segment set in the second version;
displaying the second version with the particular annotation associated with the matching particular content segment set.

2. The machine readable medium of claim 1, wherein the particular annotation comprises user-specified annotation.

3. The machine readable medium of claim 2, wherein the user specified annotation comprises a user-specified note.

4. The machine readable medium of claim 2, wherein the user specified annotation comprises a user-specified highlighting.

5. The machine readable medium of claim 2,
wherein the user specified annotation comprises a user-specified note and highlighting;
wherein the set of instructions for displaying the second version comprises a set of instructions for automatically highlighting the particular content segment set to match the highlighting of the first content segment set and for displaying the user-specified note with the particular content segment set.

6. The machine readable medium of claim 1, wherein the first set of content segments includes second and third content segment sets, the second content segment set being annotated by a user while the third content segment set comprising one or more content segments near the second content segment set that are selected to define a context around the second content segment set.

7. The machine readable medium of claim 1, wherein the set of instruction for examining different sets of content segments in the second version comprises a set of instructions for analyzing content segment sets within a section of the second version that corresponds to a section in the first version.

8. The machine readable medium of claim 1, wherein the set of instructions for examining different sets of content segments in the second version comprises sets of instructions for:
using one or more of the content segments in the first set of content segments to derive a search string;
applying the search string to a search index to identify a portion of the second version that contains the different content segment sets.

9. The machine readable medium of claim 1, wherein the first content segment set is within a first section of the first version, wherein the set of instructions for examining different sets of content segments in the second version comprises sets of instructions for:
analyzing at least one content segment set within a second section of the second version that corresponds to a first section, in order to find the matching particular set of content segments;
after not finding the matching particular content segment set in the second section, (i) using one or more of the content segments in the first set of content segments to derive a search string, and (ii) applying the search string to a search index to identify another section of the second version to search in order to find the matching particular content segment set.

10. The machine readable medium of claim 9,
wherein the document comprises a plurality of chapters and each chapter includes at least one section;
wherein the section identified with the search index is in another chapter than the second section.

11. The machine readable medium of claim 1, wherein the first content segment set is within a first section of the first version, wherein the set of instructions for examining different sets of content segments in the second version comprises sets of instructions for:
detecting that a section within the second content version that corresponds to the first section does not exist;
using one or more of the content segments in the first set of content segments to derive a search string; and
applying the search string to a search index to identify a section of the second version to search in order to find the matching particular content segment set.

12. The machine readable medium of claim 1, wherein a particular set of content segments matches the first set of content segments in the first version when the particular set of content segments are identical to the first set of content segments.

13. The machine readable medium of claim 1, wherein a particular set of content segments matches the first set of content segments in the first version when the particular set of content segments meet a particular criteria in relation to the first set of content segments.

14. The machine readable medium of claim 1, wherein the particular criteria comprises analyzing the similarity between the content segments and the first set of content segments.

15. The machine readable medium of claim 1, wherein the set of instructions for examining different sets of content segments in the second version comprises a set of instructions for examining different chapters within the second version.

16. The machine readable medium of claim 1, wherein the second version has a higher version number than the first version.

17. The machine readable medium of claim 1, wherein the set of instructions for associating the particular annotation comprises a set of instructions with linking the particular annotation to the data structure that defines the second version of the content segment.

18. A method of processing content having first and second versions that respectively comprise first and second pluralities of content segments, the first version further comprising at least one particular annotation that is specified for at least a first set of content segments in the first version, the method comprising:
examining different sets of content segments in the second version to identify a particular set of content segments that matches the first set of content segments;
upon identifying a matching particular set of content segments, associating the particular annotation with the particular set of content segments in the second version;
providing a presentation of the second version with the particular annotation associated with the matching particular set of content segments.

19. The method of claim 18, wherein the particular annotation comprises user-specified note.

20. The method of claim 18, wherein the first set of content segments includes second and third content segment sets, the second content segment set being annotated while the third content segment set comprising one or more content segments near the second content segment set that are selected to define a context around the second content segment set.

21. The method of claim 18, wherein examining different sets of content segments in the second version comprises analyzing content segment sets within a section of the second version that corresponds to a section in the first version.

22. The method of claim 18, wherein examining different sets of content segments in the second version comprises:
using one or more of the content segments in the first set of content segments to derive a search string; and
applying the search string to a search index to identify a portion of the second version to identify different content segment sets.

23. The method of claim 18, wherein the first content segment set is within a first section of the first version, wherein examining different sets of content segments in the second version comprises:
analyzing at least one content segment set within a second section of the second version that corresponds to a first section in order to find the matching particular set of content segments;
after not finding the matching particular content segment set in the second section, (i) using one or more of the content segments in the first set of content segments to derive a search string, and (ii) applying the search string to a search index to identify another section of the second version to search in order to find the matching particular content segment set.

24. The method of claim 18, wherein the particular annotation corresponds to a particular chapter within the first version of the content, the method further comprising analyzing the annotations for the particular chapter prior to analyzing the annotations for a different chapter.

25. The method of claim 18, wherein the first content segment set is within a first section of the first version, wherein examining different sets of content segments in the second version comprises:
analyzing at least one content segment set within a second section of the second version that corresponds to a first section in order to find the matching particular set of content segments;
after not finding the matching particular content segment set in the second section, analyzing a third section within a same chapter as the second section of the second version in order to find the matching particular set of content segments.
